(19) United States
(12) Patent Application Publication
(10) Pub. No.: US 2017/0255930 A1
(43) Pub. Date: Sep. 7, 2017

(54) METHOD FOR PROVIDING ELECTRONIC PAYMENT FUNCTION AND ELECTRONIC DEVICE SUPPORTING THE SAME

(71) Applicant: SAMSUNG ELECTRONICS CO., LTD., Suwon-si (KR)

(72) Inventors: Hyungil LEE, Seongnam-si (KR); Jaeman CHO, Anyang-si (KR); Minkyu LEE, Gunpo-si (KR); Boohyun CHO, Yongin-si (KR); Eun Jung HYUN, Seoul (KR); Seong-Min JE, Suwon-si (KR)

(21) Appl. No.: 15/430,756

(22) Filed: Feb. 13, 2017

(30) Foreign Application Priority Data
Mar. 2, 2016 (KR) 10-2016-0025152

(51) Int. Cl. G06Q 20/38; G06Q 20/32; G06Q 20/40

(52) U.S. Cl. CPC G06Q 20/385; G06Q 20/40; G06Q 20/327

(57) ABSTRACT

According to various example embodiments of the present disclosure, an electronic device may include a short-range communication module comprising short-range communication circuitry and a processor. The processor may be configured to receive an input, to change the electronic device to a state capable of recording information on a payment based on the input, to receive, from a first external electronic device, authentication data related to a payment performed between the electronic device and the first external electronic device using the short-range communication module based on the change of the state, and to transmit, to a second external electronic device, a request related to the payment based on the authentication data.

### CROSS-REFERENCE TO RELATED APPLICATION

This application is based on and claims priority under 35 U.S.C. §119 to a Korean patent application filed in the Korean Intellectual Property Office on Mar. 2, 2016 and assigned Serial No. 10-2016-0025152, the disclosure of which is incorporated by reference herein in its entirety.

### BACKGROUND

1. Field of the Disclosure

The present disclosure relates generally to a method of providing an electronic payment function and an electronic device supporting the method.

2. Description of Related Art

With the development of mobile communication technologies, an electronic device may perform not only a voice telephony function but also various data communication functions. The electronic device, for example, a mobile device or a user device, may provide various services through various applications. The electronic device may provide a multimedia service such as a music service, a video service, or a digital broadcasting service, or may provide a network-based communication service or the like such as telephony, wireless internet, a Short Message Service (SMS), a Multimedia Messaging Service (MMS), or the like. Further, the electronic device which has been evolved from a simple communication medium to a device capable of performing various functions such as communication, distribution, internet, payment, or the like may be used throughout society, culture, finance, or distribution industry.

For example, the electronic device may provide a mobile payment scheme in which a payment function is performed by using the electronic device. For example, in the electronic device, a payment scheme evolved from cash to a plastic card may perform a payment by using the electronic device. For example, the electronic device may use a mobile payment service to provide a payment function in which goods and services are purchased by using the electronic device on online or offline (e.g., when a payment is performed by actually purchasing a product in a shop or a restaurant).

Examples of the mobile payment scheme using the electronic device include a scheme of using the electronic device in which an application for performing a Point Of Sales (POS) function is installed, a scheme of tagging the electronic device with respect to a payment code (e.g., a Quick Response (QR) code) displayed on a display, or a scheme of using a payment proxy service through a payment proxy server.

However, the conventional mobile payment scheme using the electronic device has a disadvantage in that the electronic device is used only for sales of products (e.g., only for affiliated stores) since it is designated as a device used only for POS, or the electronic device has to access a payment proxy server whenever each process constituting a payment operation is performed through the payment proxy server for performing the POS function.

### SUMMARY

The present disclosure relates generally to a method of providing an electronic payment function and an electronic device supporting the method, so that an easy and reliable trade can be provided by operating in a payee mode (or a buyer mode) or a payer mode (or a consumer mode) on the basis of an input and by mutually authenticating a trading partner using a near-distance communication module.

Advantageous effects of the present disclosure are not limited to the aforementioned advantageous effects, and other unmentioned advantageous effects can be clearly understood by those skilled in the art from descriptions below.

According to various example embodiments of the present disclosure, an electronic device may include a short-range communication module comprising short-range communication circuitry and a processor. The processor may be configured to receive an input, to change the electronic device to a state capable of recording information of a payment at least on the basis of the input, to receive, from a first external electronic device, authentication data related to a payment performed between the electronic device and the first external electronic device using the short-range communication module at least based on the change of the state, and to transmit, to a second external electronic device, a request related to the payment based on the authentication data.

According to various example embodiments of the present disclosure, a method may include receiving an input, changing an electronic device to a state capable of recording information of a payment based on the input, receiving, from a first external electronic device, authentication data related to a payment performed between the electronic device and the first external electronic device using the short-range communication module based on the change of the state, and transmitting, to a second external electronic device, a request related to the payment at least on the basis of the authentication data.

### BRIEF DESCRIPTION OF THE DRAWINGS

The above and other aspects, features and attendant advantages of the present disclosure will be more readily appreciated and understood from the following detailed description, taken in conjunction with the accompanying drawings, in which like reference numerals refer to like elements, and wherein:

FIG. 1 is a diagram illustrating an example electronic device in a network environment according to various example embodiments of the present disclosure;

FIG. 2 is a block diagram illustrating an example structure of an electronic device according to various example embodiments of the present disclosure;

FIG. 3 is a block diagram illustrating an example program module according to various example embodiments of the present disclosure;

FIG. 4 is a diagram illustrating an example system for providing an electronic payment according to various example embodiments of the present disclosure;

FIG. 5 is a signal flow diagram illustrating an example system for providing an electronic payment according to an example embodiment of the present disclosure;

FIG. 6 is a signal flow diagram illustrating an example system for providing an electronic payment according to another example embodiment of the present disclosure;

FIG. 7 is a signal flow diagram illustrating an example system for providing an electronic payment according to another example embodiment of the present disclosure;

FIG. 8 is a flowchart illustrating an example method of providing an electronic payment by using an electronic device operating in a payer mode according to an example embodiment of the present disclosure;

FIG. 9 is a flowchart illustrating an example method of providing an electronic payment by using an electronic device operating in a payee mode according to an example embodiment of the present disclosure;

FIG. 10 is a flowchart illustrating an example method of providing an electronic payment by using an electronic device operating in a payer mode according to another example embodiment of the present disclosure;

FIG. 11 is a flowchart illustrating an example method of providing an electronic payment by using an electronic device operating in a payee mode according to another example embodiment of the present disclosure;

FIG. 12 is a flowchart illustrating an example method of providing an electronic payment by using an electronic device operating in a payer mode according to another example embodiment of the present disclosure;

FIG. 13 is a flowchart illustrating an example method of providing an electronic payment by using an electronic device operating in a payee mode according to another example embodiment of the present disclosure; and

FIGS. 14, 15, 16 and FIG. 17 are diagrams illustrating examples of a method of providing an electronic payment according to various example embodiments of the present disclosure.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first electronic device and a second electronic device may indicate different user devices regardless of order or importance thereof. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. On the other hand, it may be understood that when an element (e.g., first element) is referred to as being “directly connected,” or “directly coupled” to another element (second element), there are no element (e.g., third element) interposed between them.

The expression “configured to” used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. In some situations, the expression “device configured to” may refer to a situation in which the device, together with other devices or components, “is able to”. For example, the phrase “processor adapted (or configured) to perform A, B, and C” may refer, for example, to a dedicated processor (e.g. embedded processor) for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even when the term is defined in the present disclosure it should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like, but is not limited thereto. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like, but is not limited thereto.

According to some embodiments, the electronic device may be a home appliance. The home appliance may, for example, include at least one of a television, a digital video disk (DVD) player, an audio player, a refrigerator, an air conditioner, a cleaner, an oven, a microwave oven, a washing machine, an air purifier, a set-top box, a home automation control panel, a TV box (e.g., HomeSync™ of Samsung, Apple TV™, or Google TV™), a game console (e.g., Xbox™, Play Station™), an electronic dictionary, an electronic key, a camcorder, and an electronic frame, or the like, but is not limited thereto.

According to another embodiment, the electronic device may include at least one of various medical devices (e.g., various portable medical measuring devices (a blood glucose measuring device, a heart rate measuring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Navigation Satellite System (GNSS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature-receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

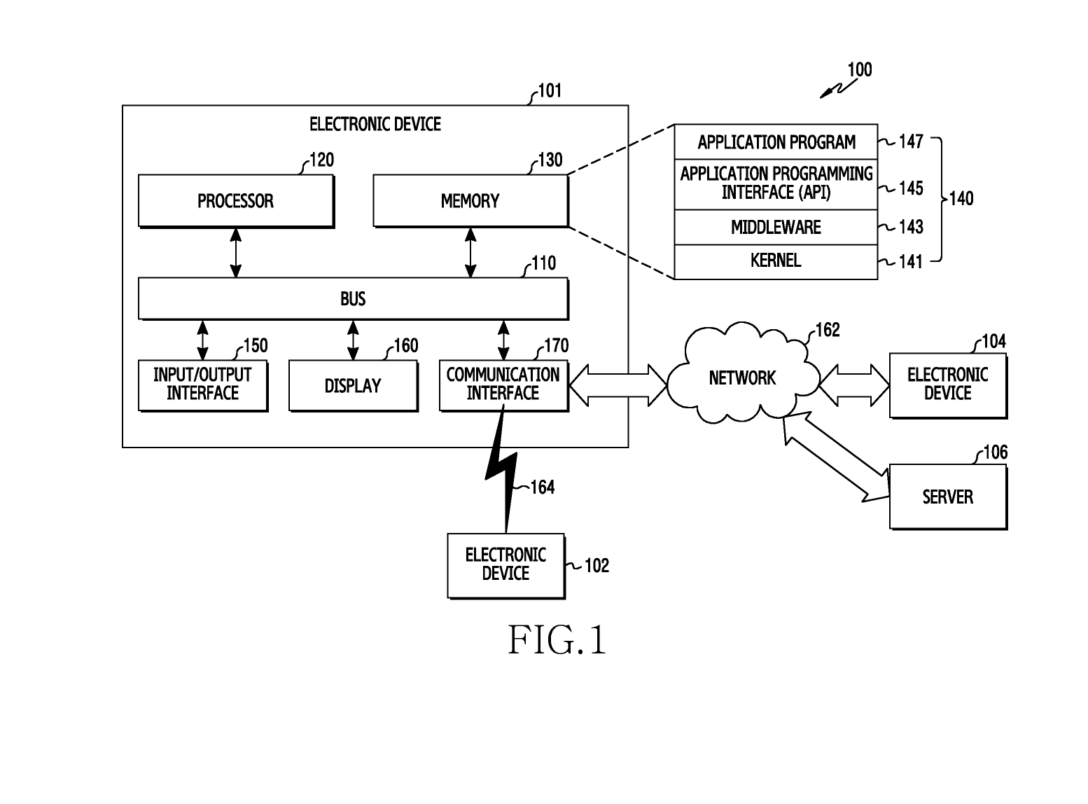

FIG. 1 is a block diagram 100 illustrating a network environment according to various example embodiments of the present disclosure. Referring to FIG. 1, an electronic device 101, 102, or 104 or a server 106 may be connected with each other through a network 162 or a short range communication 164. The term short range (or short-range) communication may be used interchangeably with the term near-distance communication throughout the disclosure. The electronic device 101 may include a bus 110, a processor (e.g., including processing circuitry) 120, a memory 130, an input/output interface (e.g., including input/output circuitry) 150, a display 160, and a communication interface (e.g., including communication circuitry) 170. In some embodiments, the electronic device 101 may omit at least one of the above elements or may further include other elements.

The bus 110 may include, for example, a circuit for interconnecting the elements 110 to 170 and transferring communication (e.g., control messages and/or data) between the elements.

The processor 120 may include various processing circuitry, such as, for example, and without limitation, one or more of a dedicated processor, a Central Processing Unit (CPU), an Application Processor (AP), and a Communication Processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may include various input/output circuitry and function as an interface that may transfer instructions or data input from a user or another external device to the other element(s) of the electronic device 101. Also, the input/output interface 150 may output, to the user or another external device, commands or data received from the element(s) other than the input/output interface 150 within the electronic device 101.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. The display 160, for example, may display various types of contents (for example, text, images, videos, icons, or symbols) for the user. The display 160 may include a touch screen and receive, for example, a touch, gesture, proximity, or hovering input by using an electronic pen or the user's body part.

The communication interface 170 may include various communication circuitry and, for example, may set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UNITS), WiBro (Wireless Broadband), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), Magnetic Stripe Transmission (MST), and Global Navigation Satellite System (GNSS).

The MST may generate a pulse according to transmission data using an electromagnetic signal and the pulse may generate a magnetic field signal. The electronic device 101 may transmit the magnetic field signal to a Point Of Sales (POS) device, and the POS device may detect the magnetic field signal using an MST reader and convert the detected magnetic field signal to an electric signal to restore the data.

The GNSS may include at least one of, for example, a Global Positioning System (GPS), a Global navigation satellite system (Glonass), a Beidou navigation satellite system (hereinafter, referred to as “Beidou”), and Galileo (European global satellite-based navigation system). Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a communication network such as a computer network (e.g., a LAN or a WAN), the Internet, and a telephone network.

Each of the first and second external electronic devices 102 and 104 may be of a type identical to or different from that of the electronic device 101. According to an embodiment, the server 106 may include a group of one or more servers. According to various embodiments, all or some of the operations performed in the electronic device 101 may be performed in another electronic device or a plurality of electronic devices (e.g., the electronic devices 102 and 104 or the server 106). According to an embodiment, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic device (e.g., the electronic device 102 or 104) or the server 106 may execute the requested functions or the additional functions, and may deliver a result of the execution to the electronic device 101. The electronic device 101 may process the received result as it is or additionally to provide the requested functions or services. To this end, for example, cloud computing, distributed computing, or client-server computing technology may be used.

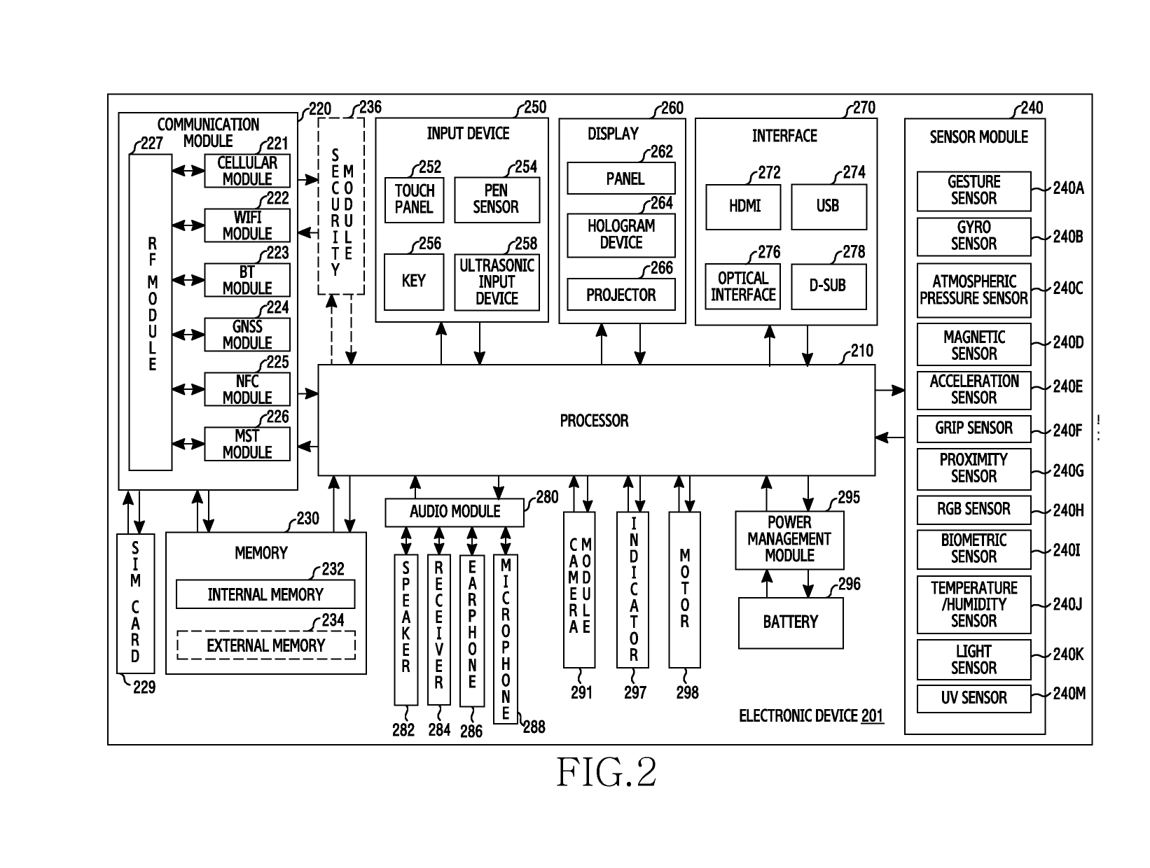

FIG. 2 is a block diagram 200 illustrating an example electronic device 201 according to various example embodiments of the present disclosure. For example, the electronic device 201 may include the whole or part of the electronic device 101 illustrated in FIG. 1. The electronic device 201 may include at least one Application Processor (AP) (e.g., including processing circuitry) 210, a communication module (e.g., including communication circuitry) 220, a Subscriber Identification Module (SIM) card 224, a memory 230, a security module 236, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a System on Chip (SoC). According to an embodiment, the processor 210 may further include a Graphic Processing Unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include various communication circuitry, such as, for example, and without limitation, a cellular module 221, a Wi-Fi module 222, a BlueTooth module 223, a GNSS module 224 (for example, a GPS module, a Glonass module, a Beidou module, or a Galileo module), an NFC module 225, an MST module 226, and a Radio Frequency (RF) module 227.

The cellular module 221 may provide a voice call, image call, a text message service, or an Internet service through, for example, a communication network. According to an embodiment, the cellular module 221 may distinguish between and authenticate electronic devices 201 within a communication network using a subscriber identification module (for example, the SIM card 229). According to an example embodiment of the present disclosure, the cellular module 221 may perform at least some of the functions that the processor 210 may provide. According to an example embodiment, the cellular module 221 may include a Communication Processor (CP).

Each of the Wi-Fi module 222, the BT module 223, the GNSS module 224, the NFC module 225 and the MST module 226 may include, for example, a processor for processing data transmitted and received through the relevant module. According to some embodiments of the present disclosure, at least some (e.g., two or more) of the cellular module 221, the Wi-Fi module 222, the BT module 223, the GNSS module 224, the NFC module 225, and the MST module 226 may be included in one Integrated Chip (IC) or IC package.

The RF module 227 may transmit/receive, for example, a communication signal (for example, an RF signal). The RF module 227 may include, for example, a transceiver, a Power Amp Module (PAM), a frequency filter, a Low Noise Amplifier (LNA), or an antenna. According to another embodiment, at least one of the cellular module 221, the Wi-Fi module 222, the Bluetooth module 223, the GNSS module 224, the NFC module 225, and the MST module 226 may transmit and receive RF signals through a separate RF module.

The subscriber identification module 229 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (for example, the memory 130) may include, for example, an internal memory 232 and/or an external memory 234. The internal memory 232 may include at least one of, for example, a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a flash memory (for example, a NAND flash memory or a NOR flash memory), a hard driver, or a Solid State Drive (SSD).

An external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a Mult-Media Card (MMC), a memory stick, or the like. The external memory 234 may be functionally and/or physically connected to the electronic device 201 through various interfaces.

The security module 236 is a module including a storage space having a higher security level than that of the memory 230 and may be a circuit guaranteeing safe data storage and a protected execution environment. For example, an electronic device may encrypt data (e.g., biometric information, personal information, or card information) which requires a high security level, and may store, in the security module 236, a key that is used for encryption. The security module 236 may be implemented by a separate circuit and may include a separate processor. The security module 236 may exist in, for example, a detachable smart chip or Secure Digital (DS) card, or may include an embedded Secure Elements (eSE) embedded in a fixed chip of the electronic device 201. Further, the security module 236 may be operated by an Operating System (OS) that is different from the OS of the electronic device 201. For example, the security module may operate on the basis of a Java Card Open Platform (JCOP) operating system.

The sensor module 240 may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, a light sensor 240K, and a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some example embodiments of the present disclosure, an electronic device 201 may further include a processor configured to control the sensor module 240 as a part of or separately from the processor 210, and may control the sensor module 240 while the processor 210 is in a sleep state.

The input device 250 may include various input circuitry, such as, for example, and without limitation, a touch panel 252, a (digital) pen sensor 254, a key 256, or an ultrasonic input device 258. The touch panel 252 may use at least one of, for example, a capacitive scheme, a resistive scheme, an infrared scheme, and an ultrasonic scheme. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wave generated by an input tool through a microphone (for example, the microphone 288) and identify data corresponding to the detected ultrasonic waves.

The display 260 (for example, the display 160) may include a panel 262, a hologram device 264 or a projector 266. The panel 262 may include a configuration identical or similar to that of the display 160 illustrated in FIG. 1. The panel 262 may be implemented to be, for example, flexible, transparent, or wearable. The panel 262 and the touch panel 252 may be configured by one module. The hologram device 264 may show a three dimensional image in the air by using an interference of light. The projector 266 may display an image by projecting light onto a screen. The screen may be located, for example, inside or outside the electronic device 201. According to an example embodiment, the display 260 may further include a control circuit for controlling the panel 262, the hologram device 264, or the projector 266.

The interface 270 may include various interface circuitry, such as, for example, and without limitation, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some elements of the audio module 280 may be included in, for example, the input/output interface 145 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 295 may manage, for example, power of the electronic device 201. According to an embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic method, and the like, and may further include additional circuits (e.g., a coil loop, a resonance circuit, a rectifier, etc.) for wireless charging. The battery gauge may measure, for example, a residual quantity of the battery 296, and a voltage, a current, or a temperature during the charging. The battery 296 may include, for example, a rechargeable battery or a solar battery.

The indicator 297 may indicate a particular state (e.g., a booting state, a message state, a charging state, or the like) of the electronic device 201 or a part (e.g., the processor 210) of the electronic device 2201. The motor 298 may convert an electrical signal into mechanical vibration, and may generate vibration, a haptic effect, or the like. Although not illustrated, the electronic device 201 may include a processing unit (e.g., a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLO™.

Each of the components of the electronic device according to the present disclosure may be implemented by one or more components, and the name of the corresponding component may vary depending on the type of the electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

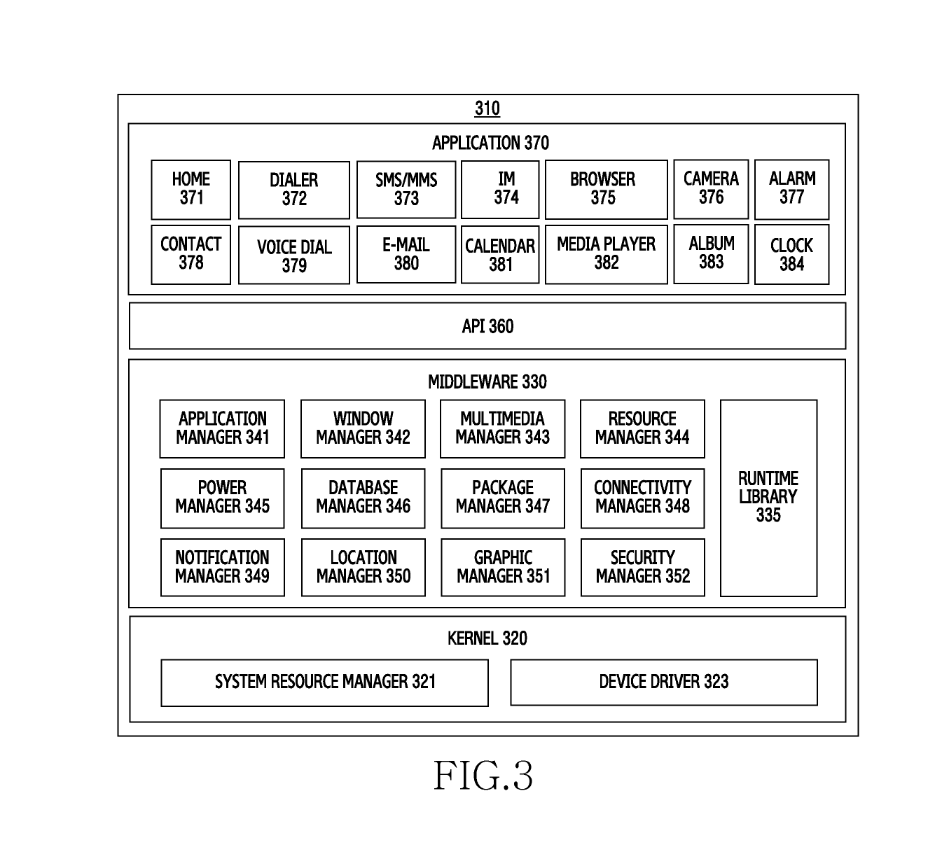

FIG. 3 is a block diagram 300 illustrating an example program module 310 according to various example embodiments of the present disclosure. According to an embodiment, the program module 310 (for example, the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an Application Programming Interface (API) 360, and/or an application 370. At least some of the program module 310 may be preloaded on the electronic device, or may be downloaded from an external electronic device (e.g., the electronic device 102 or 104, or the server 106).

The kernel 320 (for example, the kernel 141) may include, for example, a system resource manager 321 and/or a device driver 323. The system resource manager 321 may perform the control, allocation, retrieval, or the like of system resources. According to an example embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module which a compiler uses in order to add a new function through a programming language while the applications 370 are being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used for the screen. The multimedia manager 343 may determine a format required to reproduce various media files, and may encode or decode a media file by using a coder/decoder (codec) appropriate for the corresponding format. The resource manager 344 may manage resources, such as a source code, a memory, a storage space, and the like of at least one of the applications 370.

The power manager 345 may operate together with a Basic Input/Output System (BIOS) to manage a battery or power, and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic device. The graphic manager 351 may manage a graphic effect, which is to be provided to the user, or a user interface related to the graphic effect. The security manager 352 may provide various security functions required for system security, user authentication, and the like. According to an example embodiment of the present disclosure, when the electronic device (for example, the electronic device 101) has a telephone call function, the middleware 330 may further include a telephony manager for managing a voice call function or a video call function of the electronic device. The payment manager 354 may relay information for payment from the application 370 to the application 370 or kernel 320. Further, the payment manager may store information related to the payment, which has been received from an external device, in the electronic device 200 or transfer the internally stored information to an external device.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application programs 147) may include, for example, one or more applications which can provide functions such as home 371, dialer 372, SMS/MMS 373, Instant Message (IM) 374, browser 375, camera 376, alarm 377, contact 378, voice dial 379, e-mail 380, calendar 381, media player 382, album 383, clock 384, health care (for example, measure exercise quantity or blood sugar), or environment information (for example, atmospheric pressure, humidity, or temperature information).

According to an example embodiment of the present disclosure, the applications 370 may include an application (hereinafter, referred to as an “information exchange application” for convenience of description) supporting information exchange between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

For example, the device management application may manage (for example, install, delete, or update) at least one function of an external electronic device (for example, the electronic device 104) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an example embodiment, the applications 370 may include applications (for example, a health care application of a mobile medical appliance or the like) designated according to attributes of the external electronic device 102 or 104. According to an embodiment of the present disclosure, the application 370 may include an application received from the external electronic device (e.g., the server 106, or the electronic device 102 or 104). According to an example embodiment of the present disclosure, the application 370 may include a preloaded application or a third party application which can be downloaded from the server. Names of the elements of the program module 310, according to the above-described embodiments of the present disclosure, may change depending on the type of OS.

According to various example embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, refer to a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of a dedicated processor, a CPU, an Application-Specific Integrated Circuit (ASIC) chip, a Field-Programmable Gate Arrays (FPGA), and a programmable-logic device for performing operations which have been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

An electronic device described hereinafter may be the electronic device 101 of FIG. 1 or the electronic device 201 of FIG. 2. Although the electronic device 101 of FIG. 1 is exemplified as the electronic device for convenience of explanation, the present disclosure is not limited thereto.

According to various example embodiments of the present disclosure, an electronic device may include a near-distance (short-range) communication module and a processor. The processor may be configured to receive an input, change the electronic device to a state capable of recording information on a payment at least on the basis of the input, receive, from a first external electronic device, authentication data related to a payment performed between the electronic device and the first external electronic device by using the near-distance (short-range) communication module at least on the basis of the change of the state, and transmit, to a second external electronic device, a request related to the payment at least on the basis of the authentication data.

In one example embodiment, the electronic device may be configured to operate in any one of a payee mode and a payer mode for the payment.

In one example embodiment, the processor may be configured to request the second external electronic device to provide a payment identification code related to the payment.

In one example embodiment, the processor may be configured to transmit the payment identification code and content for the payment to the second external electronic device as one part of an operation of transmitting the request related to the payment. The content related to the payment may include at least one of a payment location, a payment date and time, an item, the number of payment objects, and a payment price.

In one example embodiment, the electronic device may operate in the payer mode for the payment. The processor may be configured to receive information corresponding to at least one payment means from the second external electronic device.

In one example embodiment, the processor may be configured to transmit the content for the payment to the first external electronic device by using the near-distance (short-range) communication module.

In one example embodiment, the authentication data may be configured to include a public key and private key of the first external electronic device, a payment authentication code related to the payment, or an agreement message for content for the payment.

In one example embodiment, the processor may be configured to transmit to the first external electronic device whether a condition for performing the payment with respect to the first external electronic device is satisfied at least on the basis of the authentication data.

In one example embodiment, the processor may be configured not to transmit the request when the electronic device belongs to a designated condition.

In one example embodiment, the processor may be configured to output a result for the payment-related request received from the second external electronic device by using a display or audio module operatively coupled to the processor.

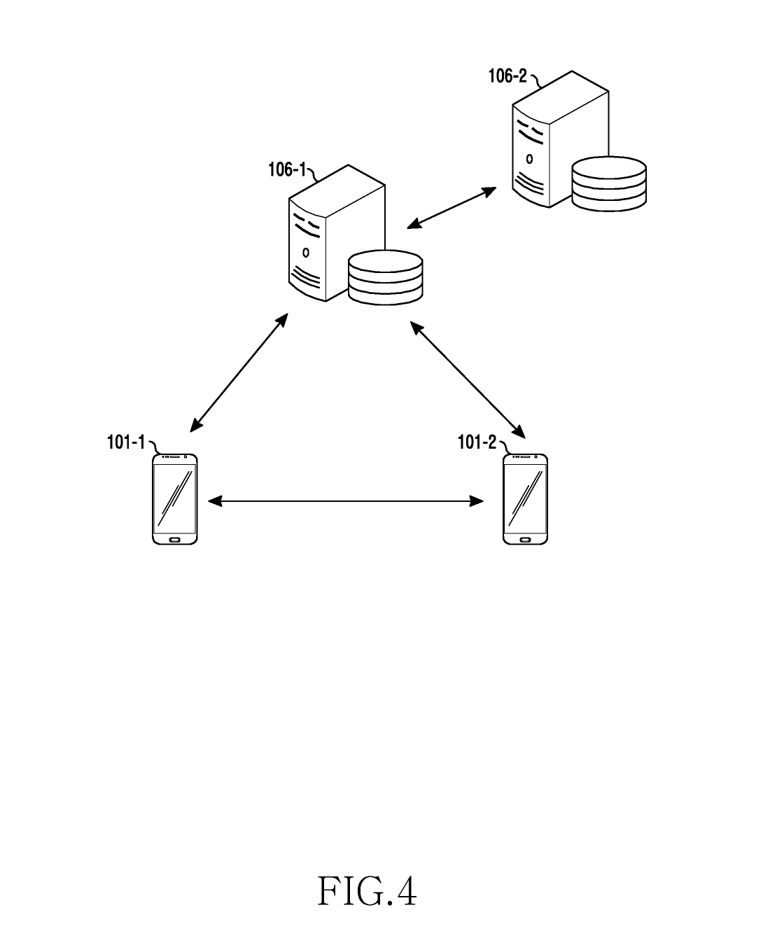

FIG. 4 is a diagram illustrating an example system for providing an electronic payment according to various example embodiments of the present disclosure.

In one example embodiment, the system for providing the electronic payment may include a 1^{st} electronic device 101-1, a 2^{nd} electronic device 101-2, a 1^{st} server 106-1, and a 2^{nd} server 106-2.

In one example embodiment, the 1^{st} electronic device 101-1 and the 2^{nd} electronic device 101-2 may operate in a payee mode or a payer mode for a payment. For example, the 1^{st} electronic device 101-1 may operate in the payee mode, and the 2^{nd} electronic device 101-2 may operate in the payer mode. In another example, the 1^{st} electronic device 101-1 may operate in the payer mode, and the 2^{nd} electronic device 101-2 may operate in the payee mode. In one example embodiment, if a trade (or a payment) is made for a product between a user of the 1^{st} electronic device 101-1 and a user of the 2^{nd} electronic device 101-2, the payee mode may be an operation mode of an electronic device for a product seller (or a person who gets paid for a product price through the payment), and the payer mode may be an operation mode of an electronic device for a buyer who buys the product (or a person who pays for the product price through the payment).

In one example embodiment, the 1^{st} electronic device 101-1 and the 2^{nd} electronic device 101-2 may operate in the payee mode or the payer mode at least on the basis of an input. For example, each of the 1^{st} electronic device 101-1 and the 2^{nd} electronic device 101-2 may operate in the payee mode or the payer mode at least on the basis of a user input. For example, if a user interface for selecting the payee mode or the payer mode (e.g., a menu including the payee mode and the payer mode) is displayed according to an execution of a payment application, the 1^{st} electronic device 101-1 and the 2^{nd} electronic device 101-2 may select the payee mode or the payer mode at least on the basis of a user selection input. In another example, the 1^{st} electronic device 101-1 or the 2^{nd} electronic device 101-2 may operate in the payer mode in response to authentication data reception from a peer electronic device. For example, in a case where the 1^{st} electronic device 101-1 or the 2^{nd} electronic device 101-2 operates in the payee mode, if authentication data including a payment identification code is received from the 2^{nd} electronic device 101-2 or the 1^{st} electronic device 101-1, the 2^{nd} electronic device 101-2 or 1^{st} electronic device 101-1 for receiving the authentication data including the payment identification code may operate in the payer mode. However, the present disclosure is not limited thereto.

In one example embodiment, the 1^{st} electronic device 101-1 and the 2^{nd} electronic device 101-2 may perform mutual authentication. For example, the 1^{st} electronic device 101-1 and the 2^{nd} electronic device 101-2 may perform authentication on the user of the 1^{st} electronic device 101-1 and the user of the 2^{nd} electronic device 101-2 by sharing the payment identification code. In one example embodiment, the payment identification code may include data for authenticating a trade (or a payment). For example, the payment identification code may include data for identifying the aforementioned trade from another trade. In one example embodiment, the payment identification code may be issued (or generated) by the server 106-1, and may be transmitted to the electronic device 101-1 or 101-2 operating in the payee mode or the payer mode. In one example embodiment, for mutual authentication, the 1^{st} electronic device 101-1 and the 2^{nd} electronic device 101-2 may share a unique key in addition to the payment identification code. For example, the 1^{st} electronic device 101-1 and the 2^{nd} electronic device 101-2 may download a payment application from the same server 106-1, and may perform a payment by using the same payment application. The 1^{st} electronic device 101-1 and the 2^{nd} electronic device 101-2 may receive a key (e.g., an application ID) unique to each of the downloaded payment applications and store it in a security region (e.g., a security module or a Trusted Execution Environment (TEE) region or the like) of the electronic device. The 1^{st} electronic device 101-1 and the 2^{nd} electronic device 101-2 may mutually transmit/receive the unique key when a trade is made, and thus may confirm that a peer electronic device is using the same payment application function from the same server 106-1. Although a unique key shared between the 1^{st} electronic device 101-1 and the 2^{nd} electronic device 101-2 is taken as an example of the key unique to the application in the aforementioned example, the present disclosure is not limited thereto. In another example embodiment, for mutual authentication, the 1^{st} electronic device 101-1 and the 2^{nd} electronic device 101-2 may use different authentication data in addition to the payment identification code. For example, the electronic device 101-1 or 101-2 operating in the payee mode displays an authentication code, and the electronic device 101-1 or 101-2 operating in the payer mode receives from the user an input of the authentication code displayed on the electronic device 101-1 or 101-2 operating in the payee mode, so that the electronic device 101-1 or 101-2 operating in the payee mode and the electronic device 101-1 or 101-2 operating in the payer mode can perform mutual authentication. In one example embodiment, the authentication code may be generated by the server 106-1 and transmitted to the electronic device 101-1 or 101-2 operating in the payee mode. However, the present disclosure is not limited thereto. In another example embodiment, for mutual authentication, the 1^{st} electronic device 101-1 and the 2^{nd} electronic device 101-2 may mutually transmit/receive a confirmation message indicating that payment content is confirmed by the user of the 1^{st} electronic device 101-1 and the user of the 2^{nd} electronic device 101-2.

In one example embodiment, the 1^{st} electronic device 101-1 and the 2^{nd} electronic device 101-2 may perform mutual authentication by using a near-field communication module. For example, the 1^{st} electronic device 101-1 and the 2^{nd} electronic device 101-2 may perform the mutual authentication in such a manner that data related to a payment is mutually transmitted/received by using the Bluetooth module 223, the NFC module 225, the WiFi module 222, the MST module 226, or the like. However, the near-distance communication module for performing the mutual authentication is not limited to the aforementioned example.

In one example embodiment, the server 106-1 may include a payment server. In one example embodiment, the payment server 106-1 may register a payment means (e.g., a card) of the 1^{st} electronic device 101-1 or a payment means of the 2^{nd} electronic device 101-2 to perform a payment. In one example embodiment, the payment server 106-1 may manage information regarding the registered payment means of the 1^{st} electronic device 101-1 or payment means of the 2^{nd} electronic device 101-2. However, the present disclosure is not limited thereto. For example, in addition to the registered payment means of the electronic device, the payment server 106-1 may manage information regarding a plurality of registered payment means including another payment means registered through another electronic device, for example, an electronic device (e.g., a wearable electronic device or an accessory (a device having a fob shape of LoopPay™)) operatively coupled to the electronic device of a user corresponding to the electronic device or an electronic device of another user.

In one example embodiment, the server 106-1 may acquire information (e.g., token information) corresponding to information of an identification means (e.g., a card) registered by the 1^{st} electronic device 101-1 and the 2^{nd} electronic device 101-2, and may transmit the acquired token information to the 1^{st} electronic device 101-1 and the 2^{nd} electronic device 101-2. For example, if the server 106-2 is a token server (or a token service provider), the server 106-1 may acquire information regarding a token issued from the server 106-2, and may transmit it to the 1^{st} electronic device 101-1 and the 2^{nd} electronic device 101-2.

In one example embodiment, the server 106-1 may transmit the payment identification code to the 1^{st} electronic device 101-1 or the 2^{nd} electronic device 101-2 in response to a payment identification code request from the 1^{st} electronic device 101-1 or the 2^{nd} electronic device 101-2.

In one example embodiment, the server 106-1 may determine whether to approve a payment in response to a payment-related request from the 1^{st} electronic device 101-1 and the 2^{nd} electronic device 101-2. For example, the server 106-1 may receive the payment identification code and payment content (e.g., a payment location, a payment date and time, a payment price, etc.) from the 1^{st} electronic device 101-1 and the 2^{nd} electronic device 101-2. The server 106-1 may confirm at least one of a validity of the payment identification code, a user corresponding to the payment identification code (or specified by the payment identification code), payment content, or the like. The server 106-1 may approve or reject the payment according to whether at least one of the validity of the payment identification code, the user corresponding to the payment identification code, the payment content, or the like is confirmed. In one example embodiment, if the payment is approved or rejected, the server 106-1 may transmit data regarding a payment result to the electronic device so that the electronic device displays a user interface corresponding to the approval or the rejection.

In one example embodiment, the server 106-2 may include at least one of a token server, a financial server, or the like.

In one example embodiment, if the server 106-2 is the token server, the server 106-2 may generate token information corresponding to a payment means and transmit it to the server 106-1 or the electronic device. In one example embodiment, if the payment means is a card, a token may be a value for substituting for a Primary Account Number (PAN) as information of the card. In another example embodiment, the token may be generated by using a Bank Identification Number (BIN) or the like. Information regarding the token may be encrypted by the token server 106-2, or may be transmitted to the server 106-1 in a non-encrypted state and thereafter may be encrypted by the server 106-1. Information regarding the encrypted token may be transmitted to the electronic device through the server 106-1 and thereafter may be decoded in the electronic device. In one example embodiment, the information regarding the token may be generated and encrypted by the token server 106-2, and may be transmitted to the electronic device without the aid of the server 106-1 (e.g., the payment server). In another example embodiment, the server 106-1 (or the payment server) may include a token generation function, and in this case, the separate token server 106-2 may be omitted. In one example embodiment, the information regarding the token may include a key for generating a token cryptogram by the electronic device 101-1 or 101-2. However, the present disclosure is not limited thereto.

In another example embodiment, if the server 106-2 is the financial server, the server 106-2 may include a server of a bank or financial company for issuing a payment means, and may confirm an identity for the payment means. In one example embodiment, if the server 106-2 is the financial server, the server 106-2 may determine whether to approve the payment in response to the payment-related request received from the server 106-1 (e.g., the payment server).

Although the server 106-1 and the server 106-2 are separately illustrated in one example embodiment of FIG. 4, the server 106-1 and the server 106-2 may be implemented as one entity according to an example embodiment. For example, the server 106-2 may be omitted, and the server 106-1 may include the payment server, the token server, the financial server, or the like. However, the present disclosure is not limited thereto.

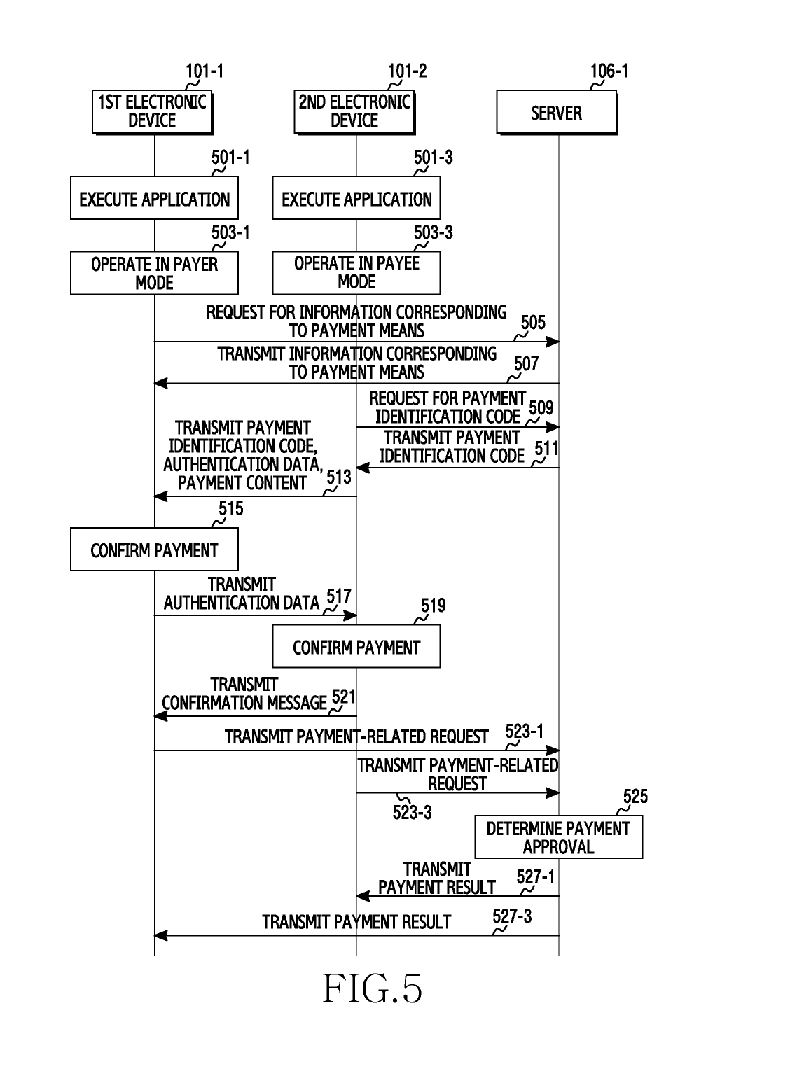

FIG. 5 is a signal flow diagram illustrating an example system for providing an electronic payment according to an example embodiment of the present disclosure.

In one example embodiment, the 1^{st} electronic device 101-1 (e.g., the processor 120) and the 2^{nd} electronic device 101-2 (e.g., the processor 120) may operate in a payee mode or a payer mode for a payment at least on the basis of an input. For example, the 1^{st} electronic device 101-1 (e.g., the processor 120) and the 2^{nd} electronic device 101-2 (e.g., the processor 120) may operate in the payee mode or the payer mode for the payment at least on the basis of a user input or an input received through a near-distance communication module. However, for convenience of explanation, FIG. 5 is described under the assumption that the 1^{st} electronic device 101-1 (e.g., the processor 120) operates in the payer mode and the 2^{nd} electronic device 101-2 (e.g., the processor 120) operates in the payee mode. Further, it is described under the assumption that the server 106-1 includes a payment server, a token server, and a financial server.

In operation 501-1 and operation 501-3, each of the 1^{st} electronic device 101-1 (e.g., the processor 120) and the 2^{nd} electronic device 101-2 (e.g., the processor 120) may execute an application, for example, a payment application. For example, when the user selects (or touches) the payment application displayed in an icon shape on the display 160 of the electronic device 101-1 or 101-2, the electronic device (e.g., the processor 120 of FIG. 1) may execute the payment application. In another example, if the user inputs a gesture or voice designated to execute the payment application, the electronic device may execute the payment application. However, the present disclosure is not limited thereto.

In one example embodiment, the operation of executing the application in operation 501-1 and operation 501-3 may further include a process in which the electronic device 101-1 or 101-2 (e.g., the processor 120) downloads the payment application from the server 106-1 and stores the downloaded payment application. For example, the electronic device 101-1 or 101-2 (e.g., the processor 120) may download the payment application from the server 106-1 for providing a payment service to which the user of the electronic device 101-1 or 101-2 is subscribed, and may store the downloaded payment application in a security region (e.g., a security module or a Trusted Execution Environment (TEE) region or the like) of the electronic device. In one example embodiment, the payment application may include Samsung Pay™ Application.

In one example embodiment, the electronic device 101-1 or 101-2 (e.g., the processor 120) may receive a unique key from the server 106-1 when the payment application is downloaded or the payment application is executed. For example, when the payment application is downloaded, the electronic device 101-1 or 101-2 (e.g., the processor 120) may receive a key (e.g., an application ID) unique (corresponding) to the downloaded payment application. For example, the key unique to the payment application may have a value which varies depending on the payment application to be transmitted by the server 106-1 to at least one electronic device. In one example embodiment, the key unique to the payment application may include data indicating that the payment application is downloaded from the server 106-1 identified from another server 106-1. For example, it may include a designated value indicating that at least one part of a value of the key unique to the payment application is downloaded from the server 106-1. In another example, the unique key may include data for confirming (or authenticating) whether to subscribe or use a payment service provided by the server 106-1 and data obtained by combining unique information of the electronic device (e.g., an identification number of the electronic device) or unique information of the user of the electronic device (e.g., an ID or the like subscribed (or registered) to the payment service) or the like. However, the present disclosure is not limited thereto. In one example embodiment, the unique key may be stored in a security region (e.g., a security module or a Trusted Execution Environment (TEE) region or the like) of the electronic device 101-1 or 101-2. In one example embodiment, the unique key may be a public key or a private key. In another example embodiment, the unique key may be a key encrypted by using the public key or the private key. However, the present disclosure is not limited thereto.

In operation 503-1, the 1^{st} electronic device 101-1 (e.g., the processor 120) may operate in the payer mode. For example, if a user interface for selecting the payee mode or the payer mode (e.g., a menu including the payee mode and the payer mode) is displayed according to an execution of a payment application, the 1^{st} electronic device 101-1 (e.g., the processor 120) may enter the payer mode at least on the basis of a user input for selecting the payer mode. In one example embodiment, the payer mode may include an operation mode for transmitting/receiving data related to a payment operation of a consumer (or a payer) for paying a payment price at least on the basis of the input, and for displaying the data related to the payment operation on the display 160. In one example embodiment, if the 1^{st} electronic device 101-1 (e.g., the processor 120) enters the payer mode, the 1^{st} electronic device 101-1 (e.g., the processor 120) may activate the near-distance communication module for performing the payment. For example, the 1^{st} electronic device 101-1 (e.g., the processor 120) may activate the Bluetooth module 223, the NFC module 225, the WiFi module 222, the MST module 226, or the like to perform the payment. However, the near-distance communication module for performing the payment is not limited to the aforementioned example.

According to various example embodiments, the operation in which the 1^{st} electronic device 101-1 (e.g., the processor 120) enters the payer mode in operation 503-1 may be performed in response to an operation of receiving data including a payment identification code or the like from the 2^{nd} electronic device 101-2 operating in the payee mode in operation 515 to be described below.

In operation 503-3, the 2^{nd} electronic device 101-2 (e.g., the processor 120) may operate in the payee mode. For example, if a user interface for selecting the payee mode or the payer mode (e.g., a menu including the payee mode and the payer mode) is displayed according to an execution of a payment application, the 2^{nd} electronic device 101-2 (e.g., the processor 120) may enter the payee mode at least on the basis of a user input for selecting the payee mode.

In one example embodiment, if the 2^{nd} electronic device 101-2 (e.g., the processor 120) enters the payee mode, the 2^{nd} electronic device 101-2 (e.g., the processor 120) may display a user interface for performing a payment on the display 160. For example, if the 2^{nd} electronic device 101-2 (e.g., the processor 120) enters the payee mode, the 2^{nd} electronic device 101-2 may be changed to a state capable of recording information regarding the payment. For example, the 2^{nd} electronic device 101-2 (e.g., the processor 120) may display a user interface for inputting payment content, for example, at least one of an item as a payment object, the number of payment objects, a price, a place, a time, a person involved in a trade, or the like on the display 160. However, the payment content is not limited to the aforementioned example.

In one example embodiment, if the 2^{nd} electronic device 101-2 (e.g., the processor 120) enters the payee mode, the 2^{nd} electronic device 101-2 (e.g., the processor 120) may activate the near-distance communication module for performing the payment. For example, the 2^{nd} electronic device 101-2 (e.g., the processor 120) may activate the Bluetooth module 223, the NFC module 225, the WiFi module 222, the MST module 226, or the like to perform the payment. However, the near-distance communication module for performing the payment is not limited to the aforementioned example. In one example embodiment, the operation in which the 2^{nd} electronic device 101-2 (e.g., the processor 120) activates the near-distance communication module may be performed in response to an operation of receiving data including a payment identification code or the like by the 2^{nd} electronic device 101-2 (e.g., the processor 120) from the server 106-1 in operation 513 to be describe below.

In operation 503-1 and operation 503-3, if the 1^{st} electronic device 101-1 (e.g., the processor 120) enters the payer mode and the 2^{nd} electronic device 101-2 (e.g., the processor 120) enters the payee mode, each of the 1^{st} electronic device 101-1 (e.g., the processor 120) and the 2^{nd} electronic device 101-2 (e.g., the processor 120) may allow only an operation related to a payment among the operations, and may block an operation not related to the payment. For example, each of the 1^{st} electronic device 101-1 and the 2^{nd} electronic device 101-2 may be configured not to perform any other commands except for a command related to the payment if many commands are performed in the processor (e.g., the processor 120 of FIG. 1). Each of the 1^{st} electronic device 101-1 (e.g., the processor 120) and the 2^{nd} electronic device 101-2 (e.g., the processor 120) may restrict capability (e.g., a storage size, a usage amount, a processing rate, a resolution, etc.) of the electronic device. However, the present disclosure is not limited thereto.

In operation 505, the 1^{st} electronic device 101-1 (e.g., the processor 120) may request the server 106-1 to provide information corresponding to a payment means. In one example embodiment, the information corresponding to the payment means may include information corresponding to a card used for a payment by the user of the 1^{st} electronic device 101-1. For example, the information corresponding to the payment means may include information regarding a token corresponding to a card selected as the payment means among a plurality of cards. In one example embodiment, in order to request for the information regarding the token, the 1^{st} electronic device 101-1 (e.g., the processor 120) may transmit information regarding the card, for example, a Primary Account Number (PAN), an expiry date, a Card Verification Value (CVV), or the like, to the server 106-1 by using the communication module 220 (e.g., the cellular module 221, etc.) operatively coupled to the electronic device.

In operation 507, the server 106-1 may transmit information corresponding to the payment means. For example, the server 106-1 may issue (or generate) a token corresponding to the payment means, and may transmit information regarding the issued token to the 1^{st} electronic device 101-1. In another example, the server 106-1 may generate a key for allowing the 1^{st} electronic device 101-1 to generate a token cryptogram, and may transmit it to the 1^{st} electronic device 101-1, in addition to information regarding the token.

In various example embodiments, operations 505 and 507 may be omitted. For example, if the 1^{st} electronic device 101-1 can store information regarding a token and a token program in a security area (e.g., a security module or a trusted execution environment (TEE) area or the like) and is in a state of being stored in the security area, operations 505 and 507 may be omitted.

In operation 509, the 2^{nd} electronic device 101-2 (e.g., the processor 120) may request the server 106-1 to provide a payment identification code (or paycode). In one example embodiment, the payment identification code may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device (e.g., the processor 120) (or after being used one time). In another example, the payment identification code may include data which configures the payment identification code to be discarded after a designated time elapses. Further, in another example, the payment identification code may include data which configures the payment identification code to be requested again after a designated time elapses. Further, in another example, the payment identification code may include data which configures a notification to be displayed when a designated time elapses (or the designated time expires). In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In various example embodiments, the operation of requesting the server 106-1 to provide the payment identification code in operation 509 may further include an operation of transmitting payment content (or content for a payment) to the server 106-1. For example, the 2^{nd} electronic device 101-2 (e.g., the processor 120) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by the user and a transmission request is input to the server 106-1, the 2^{nd} electronic device 101-2 (e.g., the processor 120) may transmit the input information to the server 106-1. In one example embodiment, the 2^{nd} electronic device 101-2 (e.g., the processor 120) may further transmit user identification information (e.g., a user ID, etc.) of the 1^{st} electronic device 101-1 as the payment content to the server.

In operation 511, the server 106-1 may issue (or generate) a payment identification code in response to a payment identification code request, and may transmit the generated payment identification code and the payment content to the 2^{nd} electronic device 101-2. For example, as described in operation 509, the server 106-1 may generate a payment identification code including data in which a usage condition is designated, and may transmit it to the 2^{nd} electronic device 101-2 together with the payment content.

In operation 513, the 2^{nd} electronic device 101-2 (e.g., the processor 120) may transmit to the 1^{st} electronic device 101-1 the payment identification code, authentication data including the unique key, payment content, or the like received from the server 106-1 by using the near-distance communication module.

In one example embodiment, operation 513 may include an operation of activating the near-distance communication module. For example, if the near-distance communication module is not activated when entering the payee mode in operation 503-3, the 2^{nd} electronic device 101-2 (e.g., the processor 120) may activate the near-distance communication module in response to payment identification transmission from the server 106-1.

In one example embodiment, the 2^{nd} electronic device 101-2 (e.g., the processor 120) may encrypt data regarding the payment identification code, the authentication data including the unique key, the payment content, or the like, and may transmit the encrypted data to the 1^{st} electronic device 101-1 by using the near-distance communication module. For example, if a public key is exchanged between the 1^{st} electronic device 101-1 and the 2^{nd} electronic device 101-2, the 2^{nd} electronic device 101-2 (e.g., the processor 120) may encrypt the data regarding the payment identification code, the authentication data including the unique key, the payment content, or the like by using the public key of the 1^{st} electronic device 101-1. However, the encryption method is not limited thereto.

In operation 515, the 1^{st} electronic device 101-1 (e.g., the processor 120) may confirm a payment at least on the basis of the payment identification code, authentication data including the unique key, payment content, or the like received from the 2^{nd} electronic device 101-2. For example, the 1^{st} electronic device 101-1 (e.g., the processor 120) may confirm the payment at least on the basis of data (or a value) included in the unique key of the 2^{nd} electronic device 101-2. For example, the 1^{st} electronic device 101-1 (e.g., the processor 120) may confirm a unique key, for example, a key unique to an application, and thus may confirm that the 2^{nd} electronic device 101-2 is using a payment application downloaded from the server 106-1 for providing the same payment service as that used by the 1^{st} electronic device 101-1. In another example, the 1^{st} electronic device 101-1 (e.g., the processor 120) may confirm a unique key, and thus may confirm that the 2^{nd} electronic device 101-2 is using the same payment service as that used by the 1^{st} electronic device 101-1. However, the present disclosure is not limited thereto.

In one example embodiment, the 1^{st} electronic device 101-1 (e.g., the processor 120) may display the payment content received from the 2^{nd} electronic device 101-2 on the display 160. The 1^{st} electronic device 101-1 (e.g., the processor 120) may receive an input for agreeing the payment content (e.g., a touch input for an icon mapped with a function for selecting the agreement of the payment content, or a voice input designated to select the agreement of the payment content) from the user, and may confirm a payment at least on the basis of the received input. In another example embodiment, the 1^{st} electronic device 101-1 (e.g., the processor 120) may receive a signature input for agreeing the payment content from the user, and may confirm the payment at least on the basis of the received input.

In one example embodiment, if the data regarding the payment identification code, the authentication data including the unique key, the payment content, or the like is encrypted, the 1^{st} electronic device 101-1 (e.g., the processor 120) may decode the encoded data. For example, if a public key is exchanged between the 1^{st} electronic device 101-1 and the 2^{nd} electronic device 101-2 and if the 2^{nd} electronic device 101-2 (e.g., the processor 120) encrypts the data regarding the payment identification code, the authentication data including the unique key, the payment content, or the like by using the public key of the 1^{st} electronic device 101-1, the 1^{st} electronic device 101-1 (e.g., the processor 120) may decode the encrypted data by using a private key of the 1^{st} electronic device 101-1. However, the decoding method may vary depending on an encrypting method performed by the 2^{nd} electronic device 101-2 or an encrypting method pre-agreed with the 2^{nd} electronic device 101-2.

In operation 517, the 1^{st} electronic device 101-1 may transmit to the 2^{nd} electronic device 101-2 authentication data including a unique key and an agreement message for the payment content. For example, the 1^{st} electronic device 101-1 (e.g., the processor 120) may transmit to the 2^{nd} electronic device 101-2 data which includes a unique key of the 1^{st} electronic device 101-1, an agreement message, for example, an agreement for the payment content input by the user, or a signature regarding the payment content.

In one example embodiment, the 1^{st} electronic device 101-1 (e.g., the processor 120) may encrypt the authentication data including the unique key and the agreement message for the payment content, and may transmit the encrypted authentication data to the 2^{nd} electronic device 101-2. For example, the 1^{st} electronic device 101-1 (e.g., the processor 120) may encrypt the authentication data including the unique key and the agreement message for the payment content by using at least one of the public key and the private key, and may transmit the encrypted data to the 2^{nd} electronic device 101-2. However, the encrypting method may be performed in various manners.

In operation 519, the 2^{nd} electronic device 101-2 (e.g., the processor 120) may confirm a payment at least on the basis of data including authentication data received from the 1^{st} electronic device 101-1, for example, data including the unique key and the agreement message for the payment content. For example, the 2^{nd} electronic device 101-2 (e.g., the processor 120) may confirm a unique key received from the 1^{st} electronic device 101-1, for example, a key unique to a payment application of the 1^{st} electronic device 101-1, and thus may confirm that the 1^{st} electronic device 101-1 is using a payment application downloaded from the server 106-1 for providing the same payment service as that used by the 2^{nd} electronic device 101-2. In another example, the 2^{nd} electronic device 101-2 (e.g., the processor 120) may confirm a unique key, and thus may confirm that the 1^{st} electronic device 101-1 is using the same payment service as that used by the 2^{nd} electronic device 101-2. However, the present disclosure is not limited thereto.

In one example embodiment, if authentication data received from the 1^{st} electronic device 101-1 is encrypted, the 2^{nd} electronic device 101-2 (e.g., the processor 120) may decode the encrypted authentication data. For example, if the authentication data is encrypted by using at least one of a public key and a private key, the 2^{nd} electronic device 101-2 (e.g., the processor 120) may decode the encrypted authentication data. However, the decoding method may be performed in various manners according to an encrypting method or the like.

In operation 521, upon confirming a payment, the 2^{nd} electronic device 101-2 (e.g., the processor 120) may transmit a confirmation message (or a response message) to the 1^{st} electronic device 101-1. For example, the 2^{nd} electronic device 101-2 (e.g., the processor 120) may transmit to the 1^{st} electronic device 101-1 the confirmation message indicating that a unique key of the 1^{st} electronic device 101-1 is confirmed. However, according to an example embodiment, the operation of receiving the confirmation message of the 1^{st} electronic device 101-1 (e.g., the processor 120) in operation 521 may be omitted.

In operation 523-1, the 1^{st} electronic device 101-1 (e.g., the processor 120) may transmit a payment-related request to the server 106-1. For example, the 1^{st} electronic device 101-1 (e.g., the processor 120) may transmit information regarding a token, a token cryptogram, payment content, a payment identification code or the like to the server 106-1.

In operation 523-3, the 2^{nd} electronic device 101-2 (e.g., the processor 120) may transmit the payment-related request to the server 106-1. For example, the 2^{nd} electronic device 101-2 (e.g., the processor 120) may transmit payment content, account information for receiving a payment price, a payment identification code, or the like to the server 106-1.

In operation 525, the server 106-1 may confirm information received from the 1^{st} electronic device 101-1 and the 2^{nd} electronic device 101-2, and may determine whether the payment is approved.

In one example embodiment, the server 106-1 may confirm that the user of the 1^{st} electronic device 101-1 is a person who pays for a payment price (or a payer) on a trade (or a payment) at least on the basis of the payment identification code received from the 1^{st} electronic device 101-1. In another example embodiment, the server 106-1 may confirm the sameness of the payment identification code issued in operation 511 and transmitted to the 2^{nd} electronic device 101-2 at least on the basis of the payment identification code received from the 2^{nd} electronic device 101-2.

In one example embodiment, the server 106-1 may confirm a validity or the like of the payment identification code. For example, the server 106-1 may confirm whether the payment identification code satisfies a condition of a designated valid time (or an expiry time) and a usage count (e.g., one time), or the like. In another example, the server 106-1 may determine the validity of the payment identification code by comparing the payment content with the usage condition designated in the payment identification code, for example, a designated time, a designated place, a designated price, a designated identity (or a condition of a designated person involved), or the like. For example, the server 106-1 may determine that the payment identification code is valid if the payment content corresponds to the usage condition designated in the payment identification code. In another example, the server 106-1 may determine that the payment identification code is invalid if the payment contend does not correspond to the usage condition designated in the payment identification code. In one example embodiment, the server 106-1 may discard (or delete) the payment identification code if it is confirmed that the payment identification code is invalid.

In one example embodiment, the server 106-1 may confirm a validity of a token at least on the basis of a token cryptogram and information regarding the token received from the 1^{st} electronic device 101-1. For example, the server 106-1 may confirm the validity of the token by using the token cryptogram. In one example embodiment, upon confirming the validity of the token, the server 106-1 may discard (or delete) information or the like regarding the token. However, the present disclosure is not limited thereto.

In one example embodiment, if the financial server is implemented separately from the server 106-1, the server 106-1 may transmit to the financial server a request for a payment approval including information or the like regarding the token. However, the present disclosure is not limited thereto.

In one example embodiment, if user identification information of the Pt electronic device 101-1 is further included in the payment content, the server 106-1 may approve or reject the payment according to whether it is identical to user identification information received from the 2^{nd} electronic device 101-2 in operation 509. For example, the server 106-1 may approve or reject the payment if the user identification information received from the 2^{nd} electronic device 101-2 in operation 509 is not identical to the user identification information included in the payment content received in operation 523-1. In one example embodiment, by confirming whether the information is identical, the server 106-1 may approve the payment only for a trade (or a payment) with a user corresponding to the user identification information included in the payment content included in the payment identification code request.

In one example embodiment, the server 106-1 may approve or reject the payment at least one the basis of a validity confirmation of a payment identification code, a token, or the like.

In operation 527-1 and operation 527-3, the server 106-1 may transmit a payment result to the 1^{st} electronic device 101-1 and the 2^{nd} electronic device 101-2. For example, the server 106-1 may transmit data including a payment approval or rejection to the 1^{st} electronic device 101-1 and the 2^{nd} electronic device 101-2.

Although not shown in FIG. 5, each of the 1^{st} electronic device 101-1 (e.g., the processor 120) and the 2^{nd} electronic device 101-2 (e.g., the processor 120) may display on the display 160 a payment result received from the server 106-1, and may operate in a normal mode by releasing the payer mode or the payee mode.

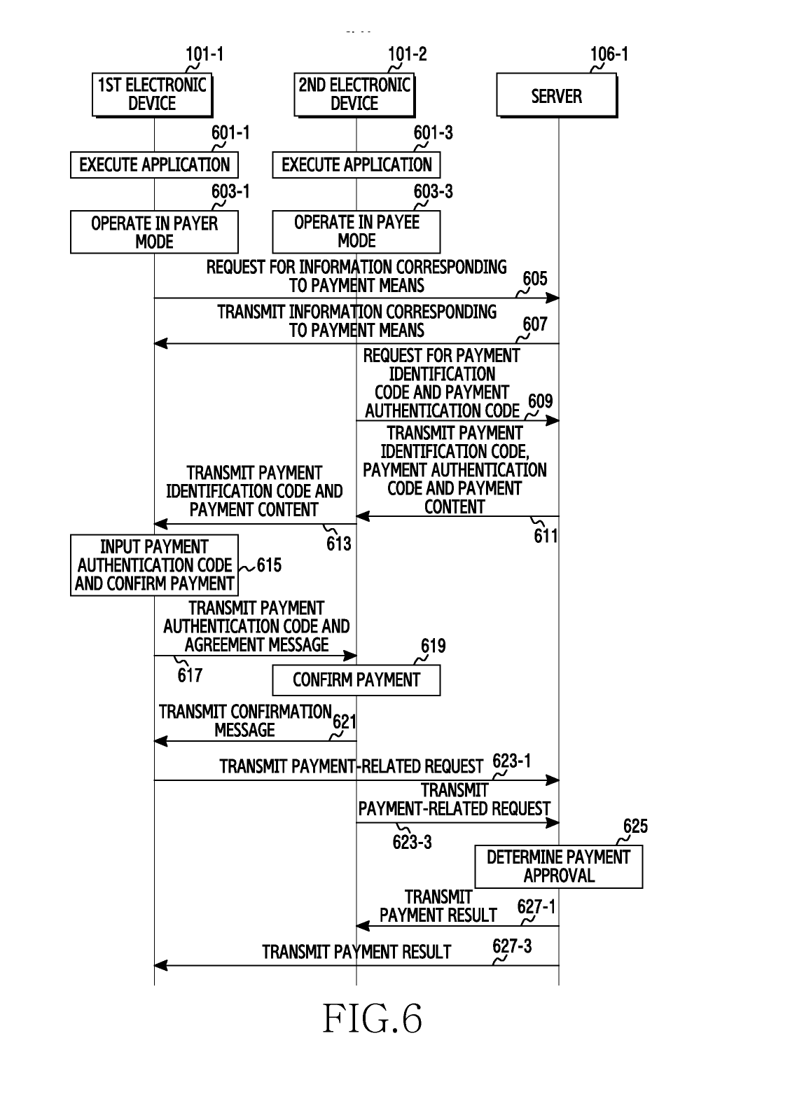

FIG. 6 is a signal flow diagram illustrating an example system for providing an electronic payment according to another example embodiment of the present disclosure.

In one example embodiment, the 1^{st} electronic device 101-1 (e.g., the processor 120) and the 2^{nd} electronic device 101-2 (e.g., the processor 120) may operate in a payee mode or a payer mode for a payment at least on the basis of an input. For example, the 1^{st} electronic device 101-1 (e.g., the processor 120) and the 2^{nd} electronic device 101-2 (e.g., the processor 120) may operate in the payee mode or the payer mode for the payment at least on the basis of a user input or an input received through a near-distance communication module. However, for convenience of explanation, FIG. 6 is described under the assumption that the 1^{st} electronic device 101-1 (e.g., the processor 120) operates in the payer mode and the 2^{nd} electronic device 101-2 (e.g., the processor 120) operates in the payee mode. Further, it is described under the assumption that the server 106-1 includes the payment server 106-1, the token server 106-1, and the financial server 106-1.

In operation 601-1 and operation 601-3, each of the 1^{st} electronic device 101-1 (e.g., the processor 120) and the 2^{nd} electronic device 101-2 (e.g., the processor 120) may execute an application, for example, a payment application. For example, if a user selects (or touches) the payment application displayed in an icon shape on the display 160 of the electronic device, the electronic device (e.g., the processor 120 of FIG. 1) may execute the payment application. In another example, if the user inputs a gesture or voice designated to execute the payment application, the electronic device may execute the payment application. However, the present disclosure is not limited thereto.

In one example embodiment, the operation of executing the application of operation 601-1 and operation 601-3 may further include a process in which the electronic device 101-1 or 101-2 (e.g., the processor 120) downloads the payment application from the server 106-1 and stores the downloaded payment application. For example, the electronic device 101-1 or 101-2 (e.g., the processor 120) may download the payment application from the server 106-1 for providing a payment service to which the user of the electronic device 101-1 or 101-2 is subscribed, and may store the downloaded payment application in a security region (e.g., a security module or a Trusted Execution Environment (TEE) region or the like) of the electronic device 101-1 or 101-2. In one example embodiment, the payment application may include Samsung Pay™ Application.

In one example embodiment, unlike operations 501-1 and 501-3 of FIG. 5, an operation of receiving a unique key from the server 106-1 may be omitted in operations 601-1 and 601-3 of FIG. 6. However, the present disclosure is not limited thereto.

In various example embodiments, since operations 603-1, 603-3, 605, and 607 of FIG. 6 are at least partially identical or similar to operations 503-1, 503-3, 505, and 507 of FIG. 5, a detailed description thereof will be omitted.

In operation 609, the 2^{nd} electronic device 101-2 (e.g., the processor 120) may request the server 106-1 to provide a payment identification code (or paycode) and a payment authentication code. In one example embodiment, the payment identification code may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device (or after being used one time). In another example, the payment identification code may include data which configures the payment identification code to be discarded after a designated time elapses. In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In one example embodiment, the payment authentication code may include data required when mutual authentication is performed between the 1^{st} electronic device 101-1 and the 2^{nd} electronic device 101-2. In one example embodiment, the payment authentication code may be issued (or generated) by the server 106-1. In one example embodiment, the payment authentication code may include data which designates a user condition (or a validity). For example, the payment authentication code may include data which designates that it is invalid if the payment authentication code is used one time. In another example, the payment authentication code may include time information (e.g., timestamp), and may include data which designates that it is invalid if not used within a designated time. For example, the payment authentication code may include data which designates that the payment authentication code is invalid if the payment authentication code is not input to the 1^{st} electronic device 101-1 within a designated time after the 2^{nd} electronic device 101-2 receives the payment authentication code from the server 106-1. In another example, the payment authentication code may include data which designates that it is valid only for a trade (or a payment) requested by the 2^{nd} electronic device 101-2 (e.g., the processor 120). However, data included in the payment authentication code to designate the user condition is not limited to the aforementioned example.

In various example embodiments, the operation of requesting the server 106-1 to provide the payment identification code in operation 609 may further include an operation of transmitting payment content (or content for a payment) to the server 106-1. For example, the 2^{nd} electronic device 101-2 (e.g., the processor 120) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by the user and a transmission request is input to the server 106-1, the 2^{nd} electronic device 101-2 (e.g., the processor 120) may transmit the input information to the server 106-1.

In operation 611, the server 106-1 may issue (or generate) a payment identification code and a payment authentication code in response to a payment identification code request, and may transmit the generated payment identification code, payment authentication code, and the payment content to the 2^{nd} electronic device 101-2. For example, as described in operation 609, the server 106-1 may generate a payment identification code and payment authentication code including data in which a usage condition is designated, and may transmit it to the 2^{nd} electronic device 101-2 together with the payment content.

In one example embodiment, if the payment authentication code is received from the server 106-1, the 2^{nd} electronic device 101-2 (e.g., the processor 120) may display the payment authentication code received by using the display 160 operatively coupled to the 2^{nd} electronic device 101-2 (e.g., the processor 120).

In operation 613, the 2^{nd} electronic device 101-2 (e.g., the processor 120) may transmit to the 1^{st} electronic device 101-1 the payment identification code, payment content, or the like received from the server 106-1 by using the near-distance communication module.

In one example embodiment, operation 613 may include an operation of activating the near-distance communication module. For example, if the near-distance communication module is not activated when entering the payee mode in operation 603-3, the 2^{nd} electronic device 101-2 (e.g., the processor 120) may activate the near-distance communication module in response to payment identification transmission from the server 106-1.

In one example embodiment, the 2^{nd} electronic device 101-2 (e.g., the processor 120) may encrypt data regarding the payment identification code, the payment content, or the like, and may transmit the encrypted data to the 1^{st} electronic device 101-1 by using the near-distance communication module. For example, if a public key is exchanged between the 1^{st} electronic device 101-1 and the 2^{nd} electronic device 101-2, the 2^{nd} electronic device 101-2 (e.g., the processor 120) may encrypt the data regarding the payment identification code, the payment content, or the like by using the public key of the 1^{st} electronic device 101-1. However, the encryption method is not limited thereto.

In operation 615, the 1^{st} electronic device 101-1 (e.g., the processor 120) may input the payment authentication code, and may confirm the payment at least on the basis of the payment identification code, payment content, or the like received from the 2^{nd} electronic device 101-2.

For example, the 1^{st} electronic device 101-1 (e.g., the processor 120) may display the payment authentication code through the display 160 operatively coupled to the 2^{nd} electronic device 101-2 (e.g., the processor 120) in operation 611, and may receive an input of the same code as the displayed payment authentication code from the user. In one example embodiment, if an input time is designated in the payment authentication code, the 1^{st} electronic device 101-1 (e.g., the processor 120) may fail to authenticate a payment if the payment authentication code cannot be received from the user within the designated time. If it is confirmed that it fails to authenticate the payment, in order to continuously authenticate the payment, the 2^{nd} electronic device 101-2 (e.g., the processor 120) may repeat operations 609 to 613. However, the present disclosure is not limited thereto.

In one example embodiment, the 1^{st} electronic device 101-1 (e.g., the processor 120) may display the payment content received from the 2^{nd} electronic device 101-2 on the display 160. The 1^{st} electronic device 101-1 (e.g., the processor 120) may receive an input for agreeing the payment content (e.g., a touch input for an icon mapped with a function for selecting the agreement of the payment content, or a voice input designated to select the agreement of the payment content) from the user, and may confirm a payment at least on the basis of the received input. In another example embodiment, the 1^{st} electronic device 101-1 may receive a signature input for agreeing the payment content from the user, and may confirm the payment at least on the basis of the received input.

In one example embodiment, if the data regarding the payment identification code, the payment content, or the like is encrypted, the 1^{st} electronic device 101-1 (e.g., the processor 120) may decode the encoded data. For example, if a public key is exchanged between the 1^{st} electronic device 101-1 and the 2^{nd} electronic device 101-2 and if the 2^{nd} electronic device 101-2 (e.g., the processor 120) encrypts the data regarding the payment identification code, the payment content, or the like by using the public key of the 1^{st} electronic device 101-1, the 1^{st} electronic device 101-1 (e.g., the processor 120) may decode the encrypted data by using a private key of the 1^{st} electronic device 101-1. However, the decoding method may vary depending on an encrypting method performed by the 2^{nd} electronic device 101-2 or an encrypting method pre-agreed with the 2^{nd} electronic device 101-2.

In operation 617, the 1^{st} electronic device 101-1 (e.g., the processor 120) may transmit to the 2^{nd} electronic device 101-2 the payment authentication code input by the user and an agreement (or confirmation) message for payment content. For example, the 1^{st} electronic device 101-1 (e.g., the processor 120) may transmit to the 2^{nd} electronic device 101-2 data which includes a code input to the 1^{st} electronic device 101-1 by the user by watching the payment authentication code displayed on the 2^{nd} electronic device 101-2, an agreement message, for example, an agreement for the payment content input by the user, or a signature regarding the payment content.

In one example embodiment, the 1^{st} electronic device 101-1 (e.g., the processor 120) may encrypt authentication data including the payment authentication code input by the user and the agreement message for the payment content, and may transmit the encrypted authentication data to the 2^{nd} electronic device 101-2. For example, the 1^{st} electronic device 101-1 (e.g., the processor 120) may encrypt the payment authentication code and the agreement message for the payment content by using at least one of the public key and the private key, and may transmit the encrypted data to the 2^{nd} electronic device 101-2. However, the encrypting method may be performed in various manners.

In another example embodiment, the 1^{st} electronic device 101-1 (e.g., the processor 120) may encrypt the agreement message for the payment content by using the payment authentication code input by the user, and may transmit the encrypted agreement message to the 2^{nd} electronic device 101-2. However, the present disclosure is not limited thereto.

Operation 619 may further include an operation for activating the near-distance communication module in response to the payment authentication code in operation 617. In one example embodiment, the 1^{st} electronic device 101-1 (e.g., the processor 120) may transmit to the 2^{nd} electronic device 101-2 the payment authentication code input by the user and an agreement (or confirmation) message for payment content by using the activated near-distance communication module.

In operation 619, the 2^{nd} electronic device 101-2 (e.g., the processor 120) may confirm the payment at least on the basis of the input payment authentication code received from the 1^{st} electronic device 101-1 and the agreement message for the payment content. For example, the 2^{nd} electronic device 101-2 (e.g., the processor 120) may confirm whether the payment authentication code received from the 1^{st} electronic device 101-1 is identical to the payment authentication code received from the server 106-1. In one example embodiment, if the 2^{nd} electronic device 101-2 (e.g., the processor 120) confirms that the payment authentication code received from the 1^{st} electronic device 101-1 is different from the payment authentication code received from the server 106-1, or if the agreement message is not received from the 1^{st} electronic device 101-1, the 2^{nd} electronic device 101-2 (e.g., the processor 120) may confirm that mutual authentication has failed. In one example embodiment, if it is confirmed that the mutual authentication has failed, in order to continuously authenticate the payment, the 2^{nd} electronic device 101-2 (e.g., the processor 120) may repeat operations 609 to 619. However, the present disclosure is not limited thereto.

In operation 621, if it is confirmed in operation 619 that the 2^{nd} electronic device 101-2 (e.g., the processor 120) confirms that the payment authentication code received from the 1^{st} electronic device 101-1 is identical to the payment authentication code received from the server 106-1 and confirms that the agreement message for the payment content is received from the 1^{st} electronic device 101-1, the 2^{nd} electronic device 101-2 (e.g., the processor 120) may transmit to the 1^{st} electronic device 101-1 a confirmation message for confirming that the payment is mutually authenticated.

In various example embodiments, since operations 623-1, 623-3, 625, 627-1, and 627-3 of FIG. 6 are at least partially identical or similar to operations 523-1, 523-3, 525, 527-1, and 527-3 of FIG. 5, a detailed description thereof will be omitted.

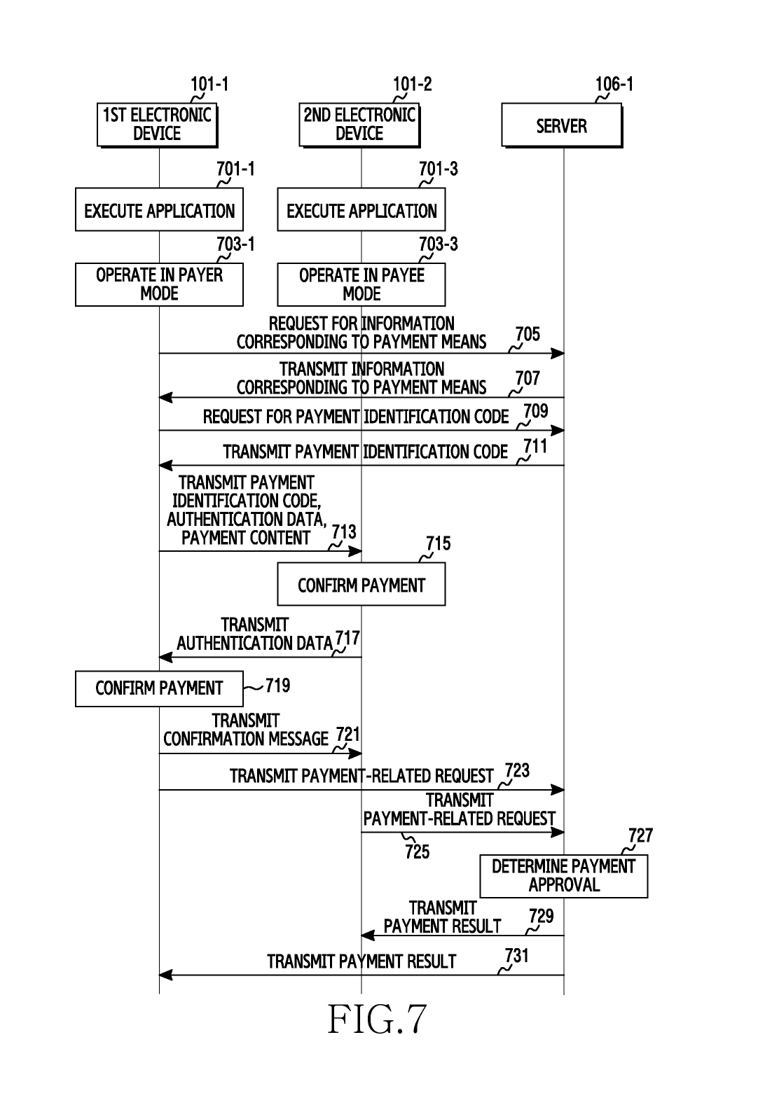

FIG. 7 is a signal flow diagram illustrating an example system for providing an electronic payment according to another example embodiment of the present disclosure.

In one example embodiment, the 1^{st} electronic device 101-1 (e.g., the processor 120) and the 2^{nd} electronic device 101-2 (e.g., the processor 120) may operate in a payee mode or a payer mode for a payment at least on the basis of an input. For example, the 1^{st} electronic device 101-1 (e.g., the processor 120) and the 2^{nd} electronic device 101-2 (e.g., the processor 120) may operate in the payee mode or the payer mode for the payment at least on the basis of a user input or an input received through a near-distance communication module. However, for convenience of explanation, FIG. 7 is described under the assumption that the 1^{st} electronic device 101-1 (e.g., the processor 120) operates in the payer mode and the 2^{nd} electronic device 101-2 (e.g., the processor 120) operates in the payee mode. Further, it is described under the assumption that the server 106-1 includes the payment server 106-1, the token server 106-1, and the financial server 106-1.

Since operations 701-1 and 701-3 of FIG. 7 are at least partially identical or similar to operations 501-1 and 501-3 of FIG. 5, a detailed description thereof will be omitted.

In operation 703-1, the 1^{st} electronic device 101-1 (e.g., the processor 120) may operate in the payer mode. For example, if a user interface for selecting the payee mode or the payer mode (e.g., a menu including the payee mode and the payer mode) is displayed according to an execution of a payment application, the 1^{st} electronic device 101-1 (e.g., the processor 120) may enter the payer mode at least on the basis of a user input for selecting the payer mode. In one example embodiment, the payer mode may include an operation mode for transmitting/receiving data related to a payment operation of a consumer (or a payer) for paying a payment price at least on the basis of the input, and for displaying the data related to the payment operation on the display 160. In one example embodiment, if the 1^{st} electronic device 101-1 (e.g., the processor 120) enters the payer mode, the 1^{st} electronic device 101-1 (e.g., the processor 120) may activate the near-distance communication module for performing the payment. For example, the 1^{st} electronic device 101-1 (e.g., the processor 120) may activate the Bluetooth module 223, the NFC module 225, the WiFi module 222, the MST module 226, or the like to perform the payment. However, the near-distance communication module for performing the payment is not limited to the aforementioned example.

In one example embodiment, operation 703-1 may further include an operation of displaying the payment content by the 1^{st} electronic device 101-1 (e.g., the processor 120). For example, if the 1^{st} electronic device 101-1 (e.g., the processor 120) enters the payer mode, the 1^{st} electronic device 101-1 (e.g., the processor 120) may display a user interface for performing a payment on the display 160 operatively coupled to the 1^{st} electronic device 101-1 (e.g., the processor 120). For example, if the 1^{st} electronic device 101-1 (e.g., the processor 120) enters the payer mode, the 1^{st} electronic device 101-1 (e.g., the processor 120) may be changed to a state capable of recording information regarding the payment. For example, the 1^{st} electronic device 101-1 (e.g., the processor 120) may display a user interface for inputting payment content, for example, at least one of an item as a payment object, the number of payment objects, a price, a place, a time, a person involved in a trade, or the like on the display 160. However, the payment content is not limited to the aforementioned example.

In operation 703-3, the 2^{nd} electronic device 101-2 (e.g., the processor 120) may operate in the payee mode. For example, if a user interface for selecting the payee mode or the payer mode (e.g., a menu including the payee mode and the payer mode) is displayed according to an execution of a payment application, the 2^{nd} electronic device 101-2 (e.g., the processor 120) may enter the payee mode at least on the basis of a user input for selecting the payee mode.

In operation 703-1 and operation 703-3, if the 1^{st} electronic device 101-1 (e.g., the processor 120) enters the payer mode and the 2^{nd} electronic device 101-2 (e.g., the processor 120) enters the payee mode, each of the 1^{st} electronic device 101-1 (e.g., the processor 120) and the 2^{nd} electronic device 101-2 (e.g., the processor 120) may allow only an operation related to a payment among the operations, and may block an operation not related to the payment. For example, each of the 1^{st} electronic device 101-1 and the 2^{nd} electronic device 101-2 may be configured not to perform any other commands except for a command related to the payment if many commands are performed in the processor. Each of the 1^{st} electronic device 101-1 (e.g., the processor 120) and the 2^{nd} electronic device 101-2 (e.g., the processor 120) may restrict capability (e.g., a storage size, a usage amount, a processing rate, a resolution, etc.) of the electronic device. However, the present disclosure is not limited thereto.

In operation 705, the 1^{st} electronic device 101-1 (e.g., the processor 120) may request the server 106-1 to provide information corresponding to a payment means. In one example embodiment, the information corresponding to the payment means may include information corresponding to a card used for a payment by a user of the 1^{st} electronic device 101-1. For example, the information corresponding to the payment means may include information regarding a token corresponding to a card selected as the payment means among a plurality of cards. In one example embodiment, in order to request for the information regarding the token, the 1^{st} electronic device 101-1 (e.g., the processor 120) may transmit information regarding the card, for example, a Primary Account Number (PAN), an expiry date, a Card Verification Value (CVV), or the like, to the server 106-1 by using the communication module 220 (e.g., the cellular module 221, etc.) operatively coupled to the electronic device.

In operation 707, the server 106-1 may transmit information corresponding to the payment means. For example, the server 106-1 may issue (or generate) a token corresponding to the payment means, and may transmit information regarding the issued token to the 1^{st} electronic device 101-1. In another example, the server 106-1 may generate a key for allowing the 1^{st} electronic device 101-1 to generate a token cryptogram, and may transmit it to the 1^{st} electronic device 101-1, in addition to information regarding the token.

In various example embodiments, operations 705 and 707 may be omitted. For example, if the 1^{st} electronic device 101-1 (e.g., the processor 120) can store information regarding a token and a token program in a security area (e.g., a security module or a trusted execution environment (TEE) area or the like) and is in a state of being stored in the security area, operations 705 and 707 may be omitted.

In operation 709, the 1^{st} electronic device 101-1 (e.g., the processor 120) may request the server 106-1 to provide a payment identification code (or paycode). In one example embodiment, the payment identification code may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device (or after being used one time). In another example, the payment identification code may include data which configures the payment identification code to be discarded after a designated time elapses. Further, in another example, the payment identification code may include data which configures the payment identification code to be requested again after a designated time elapses. Further, in another example, the payment identification code may include data which configures a notification to be displayed when a designated time elapses (or the designated time expires). In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In various example embodiments, the operation of requesting the server 106-1 to provide the payment identification code in operation 709 may further include an operation of transmitting payment content (or content for a payment) to the server 106-1. For example, the 1^{st} electronic device 101-1 (e.g., the processor 120) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by a user and a transmission request is input to the server 106-1, the 1^{st} electronic device 101-1 (e.g., the processor 120) may transmit the input information to the server 106-1.

In operation 711, the server 106-1 may issue (or generate) a payment identification code in response to a payment identification code request, and may transmit the generated payment identification code and the payment content to the 1^{st} electronic device 101-1. For example, as described in operation 709, the server 106-1 may generate a payment identification code including data in which a usage condition is designated, and may transmit it to the 1^{st} electronic device 101-1 together with the payment content.

In operation 713, the 1^{st} electronic device 101-1 (e.g., the processor 120) may transmit to the 2^{nd} electronic device 101-2 the payment identification code, authentication data including the unique key, payment content, or the like received from the server 106-1 by using the near-distance communication module.

In one example embodiment, operation 713 may include an operation of activating the near-distance communication module. For example, if the near-distance communication module is not activated when entering the payer mode in operation 703-3, the 1^{st} electronic device 101-1 (e.g., the processor 120) may activate the near-distance communication module in response to payment identification transmission from the server 106-1.

In one example embodiment, the 1^{st} electronic device 101-1 (e.g., the processor 120) may encrypt data regarding the payment identification code, the authentication data including the unique key, the payment content, or the like, and may transmit the encrypted data to the 2^{nd} electronic device 101-2 by using the near-distance communication module. For example, if a public key is exchanged between the 1^{st} electronic device 101-1 and the 2^{nd} electronic device 101-2, the 1^{st} electronic device 101-1 (e.g., the processor 120) may encrypt the data regarding the payment identification code, the authentication data including the unique key, the payment content, or the like by using the public key of the 2^{nd} electronic device 101-2. However, the encryption method is not limited thereto.

In operation 715, the 2^{nd} electronic device 101-2 (e.g., the processor 120) may confirm a payment at least on the basis of the payment identification code, authentication data including the unique key, payment content, or the like received from the 1^{st} electronic device 101-1. For example, the 2^{nd} electronic device 101-2 (e.g., the processor 120) may confirm the payment at least on the basis of data (or a value) included in the unique key of the 1^{st} electronic device 101-1. For example, the 2^{nd} electronic device 101-2 (e.g., the processor 120) may confirm a unique key, for example, a key unique to an application, and thus may confirm that the 1^{st} electronic device 101-1 is using a payment application downloaded from the server 106-1 for providing the same payment service as that used by the 2^{nd} electronic device 101-2. In another example, the 2^{nd} electronic device 101-2 (e.g., the processor 120) may confirm a unique key, and thus may confirm that the 1^{st} electronic device 101-1 is using the same payment service as that used by the 2^{nd} electronic device 101-2. However, the present disclosure is not limited thereto.

In one example embodiment, the 2^{nd} electronic device 101-2 (e.g., the processor 120) may display the payment content received from the 1^{st} electronic device 101-1 on the display 160. The 2^{nd} electronic device 101-2 may receive an input for agreeing the payment content (e.g., a touch input for an icon mapped with a function for selecting the agreement of the payment content, or a voice input designated to select the agreement of the payment content) from a user, and may confirm a payment at least on the basis of the received input. In another example embodiment, the 2^{nd} electronic device 101-2 (e.g., the processor 120) may receive a signature input for agreeing the payment content from the user, and may confirm the payment at least on the basis of the received input.

In one example embodiment, if the data regarding the payment identification code, the authentication data including the unique key, the payment content, or the like is encrypted, the 2^{nd} electronic device 101-2 (e.g., the processor 120) may decode the encoded data. For example, if a public key is exchanged between the 2^{nd} electronic device 101-2 and 1^{st} electronic device 101-1 and if the 1^{st} electronic device 101-1 encrypts the data regarding the payment identification code, the authentication data including the unique key, the payment content, or the like by using the public key of the 2^{nd} electronic device 101-2, the 2^{nd} electronic device 101-2 (e.g., the processor 120) may decode the encrypted data by using a private key of the 2^{nd} electronic device 101-2. However, the decoding method may vary depending on an encrypting method performed by the 1^{st} electronic device 101-1 (e.g., the processor 120) or an encrypting method pre-agreed with the 2^{nd} electronic device 101-2.

In operation 717, the 2^{nd} electronic device 101-2 (e.g., the processor 120) may transmit to the 1^{st} electronic device 101-1 authentication data including a unique key and an agreement message for the payment content. For example, the 2^{nd} electronic device 101-2 (e.g., the processor 120) may transmit to the 1^{st} electronic device 101-1 data which includes a unique key of the 2^{nd} electronic device 101-2, an agreement message, for example, an agreement for the payment content input by the user, or a signature regarding the payment content.

In one example embodiment, the 2^{nd} electronic device 101-2 (e.g., the processor 120) may encrypt the authentication data including the unique key and the agreement message for the payment content, and may transmit the encrypted authentication data to the 1^{st} electronic device 101-1. For example, the 2^{nd} electronic device 101-2 (e.g., the processor 120) may encrypt the authentication data including the unique key and the agreement message for the payment content by using at least one of the public key and the private key, and may transmit the encrypted data to the 1^{st} electronic device 101-1. However, the encrypting method may be performed in various manners.

In operation 719, the 1^{st} electronic device 101-1 (e.g., the processor 120) may confirm a payment at least on the basis of data including authentication data received from the 2^{nd} electronic device 101-2, for example, data including the unique key and the agreement message for the payment content. For example, the 1^{st} electronic device 101-1 (e.g., the processor 120) may confirm a unique key received from the 2^{nd} electronic device 101-2, for example, a key unique to a payment application of the 2^{nd} electronic device 101-2, and thus may confirm that the 2^{nd} electronic device 101-2 is using a payment application downloaded from the server 106-1 for providing the same payment service as that used by the 1^{st} electronic device 101-1. In another example, the 1^{st} electronic device 101-1 (e.g., the processor 120) may confirm a unique key, and thus may confirm that the 2^{nd} electronic device 101-2 (e.g., the processor 120) is using the same payment service as that used by the 1^{st} electronic device 101-1. However, the present disclosure is not limited thereto.

In one example embodiment, if authentication data received from the 2^{nd} electronic device 101-2 is encrypted, the 1^{st} electronic device 101-1 (e.g., the processor 120) may decode the encrypted authentication data. For example, if the authentication data is encrypted by using at least one of a public key and a private key, the 1^{st} electronic device 101-1 (e.g., the processor 120) may decode the encrypted authentication data. However, the decoding method may be performed in various manners according to an encrypting method or the like.

In operation 721, upon confirming a payment, the 1^{st} electronic device 101-1 (e.g., the processor 120) may transmit a confirmation message (or a response message) to the 2^{nd} electronic device 101-2. For example, the 1^{st} electronic device 101-1 (e.g., the processor 120) may transmit to the 2^{nd} electronic device 101-2 the confirmation message indicating that a unique key of the 2^{nd} electronic device 101-2 is confirmed. However, according to an example embodiment, the operation of receiving the confirmation message of the 1^{st} electronic device 101-1 (e.g., the processor 120) in operation 721 may be omitted.

In operation 723, the 1^{st} electronic device 101-1 (e.g., the processor 120) may transmit a payment-related request to the server 106-1. For example, the 1^{st} electronic device 101-1 (e.g., the processor 120) may transmit information regarding a token, a token cryptogram, payment content, a payment identification code or the like to the server 106-1.

In operation 725, the 2^{nd} electronic device 101-2 (e.g., the processor 120) may transmit the payment-related request to the server 106-1. For example, the 2^{nd} electronic device 101-2 may transmit payment content, account information for receiving a payment price, a payment identification code, or the like to the server 106-1.

In operation 727, the server 106-1 may confirm information received from the 1^{st} electronic device 101-1 and the 2^{nd} electronic device 101-2, and may determine whether the payment is approved.

In one example embodiment, the server 106-1 may confirm that the user of the 1^{st} electronic device 101-1 is a person who pays for a payment price (or a payer) on a trade (or a payment) at least on the basis of the payment identification code received from the 1^{st} electronic device 101-1. In another example embodiment, the server 106-1 may confirm the sameness of the payment identification code issued in operation 711 and transmitted to the 1^{st} electronic device 101-1 at least on the basis of the payment identification code received from the 1^{st} electronic device 101-1.

In one example embodiment, the server 106-1 may confirm a validity or the like of the payment identification code. For example, the server 106-1 may confirm whether the payment identification code satisfies a condition of a designated valid time (or an expiry time) and a usage count (e.g., one time), or the like. In another example, the server 106-1 may determine the validity of the payment identification code by comparing the payment content with the usage condition designated in the payment identification code, for example, a designated time, a designated place, a designated price, a designated identity (or a condition of a designated person involved), or the like. For example, the server 106-1 may determine that the payment identification code is valid if the payment content corresponds to the usage condition designated in the payment identification code. In another example, the server 106-1 may determine that the payment identification code is invalid if the payment contend does not correspond to the usage condition designated in the payment identification code. In one example embodiment, the server 106-1 may discard (or delete) the payment identification code if it is confirmed that the payment identification code is invalid.

In one example embodiment, the server 106-1 may confirm a validity of a token at least on the basis of a token cryptogram and information regarding the token received from the 1^{st} electronic device 101-1. For example, the server 106-1 may confirm the validity of the token by using the token cryptogram. In one example embodiment, upon confirming the validity of the token, the server 106-1 may discard (or delete) information or the like regarding the token. However, the present disclosure is not limited thereto.

In one example embodiment, if the financial server 106-1 is implemented separately from the server 106-1, the server 106-1 may transmit a request for a payment approval including information regarding a token or the like to the financial server 106-1. However, the present disclosure is not limited thereto.

In one example embodiment, the server 106-1 may approve or reject the payment at least one the basis of a validity confirmation of a payment identification code, a token, or the like.

In operation 729 and operation 731, the server 106-1 may transmit a payment result to the 1^{st} electronic device 101-1 and the 2^{nd} electronic device 101-2. For example, the server 106-1 may transmit data including a payment approval or rejection to the 1^{st} electronic device 101-1 and the 2^{nd} electronic device 101-2.

Although not shown in FIG. 7, each of the 1^{st} electronic device 101-1 (e.g., the processor 120) and the 2^{nd} electronic device 101-2 (e.g., the processor 120) may display on the display 160 a payment result received from the server 106-1, and may operate in a normal mode by releasing the payer mode or the payee mode.

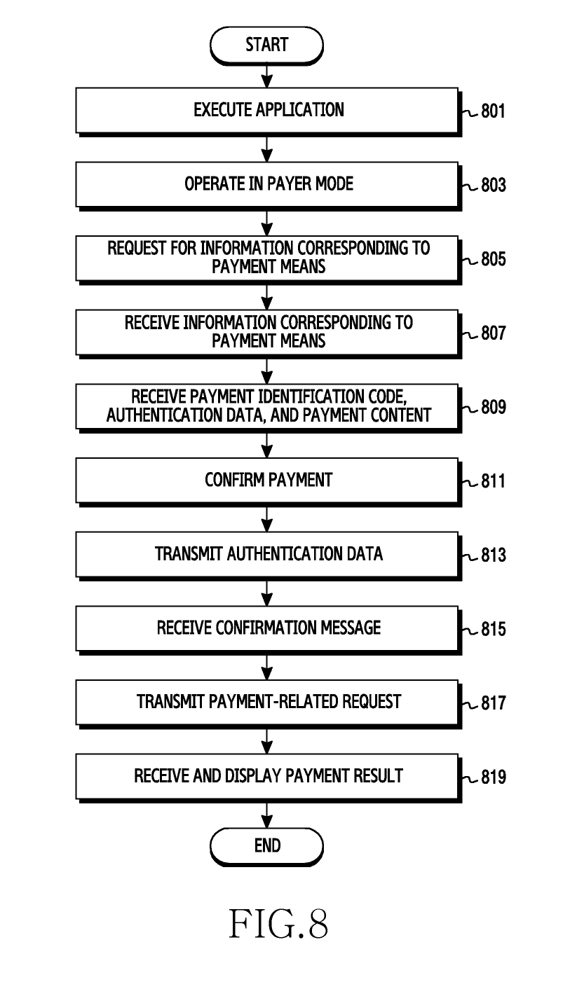

FIG. 8 is a flowchart illustrating an example method of providing an electronic payment using an electronic device operating in a payer mode according to an example embodiment of the present disclosure.

In operation 801, the electronic device (e.g., the processor 120 of FIG. 1) may execute an application, for example, a payment application. For example, if a user selects (or touches) the payment application displayed in an icon shape on the display 160 of the electronic device (e.g., the processor 120 of FIG. 1), the electronic device (e.g., the processor 120 of FIG. 1) may execute the payment application. In another example, if the user inputs a gesture or voice designated to execute the payment application, the electronic device may execute the payment application. However, the present disclosure is not limited thereto.

In one example embodiment, the operation of executing the application of the operation 801 may further include a process in which the electronic device (e.g., the processor 120 of FIG. 1) downloads the payment application from the server 106-1 and stores the downloaded payment application. For example, the electronic device (e.g., the processor 120 of FIG. 1) may download the payment application from the server 106-1 for providing a payment service to which the user of the electronic device 101 is subscribed, and may store the downloaded payment application in a security region (e.g., a security module or a Trusted Execution Environment (TEE) region or the like) of the electronic device. In one example embodiment, the payment application may include Samsung Pay™ Application.

In one example embodiment, the electronic device (e.g., the processor 120 of FIG. 1) may receive a unique key from the server 106-1 when the payment application is downloaded or the payment application is executed. For example, when the payment application is downloaded, the electronic device (e.g., the processor 120 of FIG. 1) may receive a key (e.g., an application ID) unique (corresponding) to the downloaded payment application. For example, the key unique to the payment application may have a value which varies depending on the payment application to be transmitted by the server 106-1 to at least one electronic device. In one example embodiment, the key unique to the payment application may include data indicating that the payment application is downloaded from the server 106-1 identified from another server 106-1. For example, it may include a designated value indicating that at least one part of a value of the key unique to the payment application is downloaded from the server 106-1. In another example, the unique key may include data for confirming (or authenticating) whether to subscribe or use a payment service provided by the server 106-1 and data obtained by combining unique information of the electronic device 101 (e.g., an identification number of the electronic device) or unique information of the user of the electronic device 101 (an ID or the like subscribed (or registered) to the payment service) or the like. However, the present disclosure is not limited thereto. In one example embodiment, the unique key may be stored in a security region (e.g., a security module or a Trusted Execution Environment (TEE) region or the like) of the electronic device 101. In one example embodiment, the unique key may be a public key or a private key. In another example embodiment, the unique key may be a key encrypted by using the public key or the private key. However, the present disclosure is not limited thereto.

In operation 803, the electronic device 101 (e.g., the processor 120) may operate in the payer mode. For example, if a user interface for selecting the payee mode or the payer mode (e.g., a menu including the payee mode and the payer mode) is displayed according to an execution of a payment application, the electronic device 101 (e.g., the processor 120) may enter the payer mode at least on the basis of a user input for selecting the payer mode. In one example embodiment, the payer mode may include an operation mode for transmitting/receiving data related to a payment operation of a consumer (or a payer) for paying a payment price at least on the basis of the input, and for displaying the data related to the payment operation on the display 160. In one example embodiment, if the electronic device 101 (e.g., the processor 120) enters the payer mode, the electronic device (e.g., the processor 120 of FIG. 1) may activate a near-distance communication module for performing the payment. For example, the electronic device (e.g., the processor 120 of FIG. 1) may activate the Bluetooth module 223, the NFC module 225, the WiFi module 222, the MST module 226, or the like to perform the payment. However, the near-distance communication module for performing the payment is not limited to the aforementioned example.

According to various example embodiments, the operation in which the electronic device 101 (e.g., the processor 120) enters the payer mode in the operation 803 may be performed in response to an operation of receiving data including a payment identification code or the like from an external electronic device operating in the payee mode in operation 809 to be described below.

In one example embodiment, if the electronic device 101 enters the payer mode in operation 803, the electronic device (e.g., the processor 120 of FIG. 1) may allow only an operation related to a payment among the operations, and may block an operation not related to the payment. For example, the electronic device (e.g., the processor 120 of FIG. 1) may be configured not to perform any other commands except for a command related to the payment if many commands are performed in the processor. The electronic device (e.g., the processor 120 of FIG. 1) may restrict capability (e.g., a storage size, a usage amount, a processing rate, a resolution, etc.) of the electronic device. However, the present disclosure is not limited thereto.

In operation 805, the electronic device (e.g., the processor 120 of FIG. 1) may request the server 106-1 to provide information corresponding to a payment means. In one example embodiment, the information corresponding to the payment means may include information corresponding to a card used for a payment by a user of the electronic device 101. For example, the information corresponding to the payment means may include information regarding a token corresponding to a card selected as the payment means among a plurality of cards. In one example embodiment, if a plurality of cards are registered to the electronic device 101 (or a payment application), the electronic device (e.g., the processor 120 of FIG. 1) may select one of images corresponding to the plurality of cards displayed through the display 160 operatively coupled to the electronic device 101. For example, the electronic device (e.g., the processor 120 of FIG. 1) may select a card to be used for a payment among the plurality of cards by receiving from a user a touch input on an image corresponding to the card, a designated gesture, or a designated voice input. However, a card selecting method is not limited to the aforementioned example.

In one example embodiment, in order to request for the information regarding the token, the electronic device (e.g., the processor 120 of FIG. 1) may transmit information regarding the card, for example, a Primary Account Number (PAN), an expiry date, a Card Verification Value (CVV), or the like, to the server 106-1 by using the communication module 220 (e.g., the cellular module 221, etc.) operatively coupled to the electronic device.

In operation 807, the electronic device (e.g., the processor 120 of FIG. 1) may receive information corresponding to the payment means from the server 106-1. For example, the electronic device (e.g., the processor 120 of FIG. 1) may receive, from the server 106-1, information regarding the token corresponding to the payment means issued by the server 106-1. In another example, the electronic device (e.g., the processor 120 of FIG. 1) may receive a key for allowing the electronic device (e.g., the processor 120 of FIG. 1) to generate a token cryptogram in addition to information regarding the token from the server 106-1.

In various example embodiments, operations 805 and 807 may be omitted. For example, if the electronic device (e.g., the processor 120 of FIG. 1) can store information regarding a token and a token program in a security area (e.g., a security module or a trusted execution environment (TEE) area or the like) and is in a state of being stored in the security area, operations 805 and 807 may be omitted.

In operation 809, the electronic device (e.g., the processor 120 of FIG. 1) may receive a payment identification code, authentication data including a unique key, and payment content or the like from the external electronic device by using the near-distance communication module.

In one example embodiment, the payment identification code is data requested for the server 106-1 by the external electronic device, issued by the server 106-1 in response to the request, and transmitted to the external electronic device, and may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device (or after being used one time). In another example, the payment identification code may include data which configures the payment identification code to be discarded after a designated time elapses. Further, in another example, the payment identification code may include data which configures the payment identification code to be requested again after a designated time elapses. Further, in another example, the payment identification code may include data which configures a notification to be displayed when a designated time elapses (or the designated time expires). In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In one example embodiment, the authentication data including the unique key may include at least one of an application of the external electronic device and a key unique to the external electronic device and a user of the external electronic device. However, the present disclosure is not limited thereto.

In one example embodiment, the payment content may include the payment content input from the external electronic device, for example, a payment location, a payment date and time, an item, the number of payment objects, a payment price, or the like. However, the payment content is not limited to the aforementioned example.

In one example embodiment, the electronic device (e.g., the processor 120 of FIG. 1) may receive data for encrypting data regarding a payment identification code, authentication data including a unique key, and payment content or the like from the external electronic device. For example, if a public key is exchanged between the electronic device 101 and the external electronic device, data regarding the payment identification code encrypted in the external electronic device by using the public key of the electronic device, the authentication data including the unique key, the payment content, or the like may be received from the external electronic device. However, an encrypting method performed by the external electronic device is not limited thereto.

In operation 811, the electronic device (e.g., the processor 120 of FIG. 1) may confirm a payment at least on the basis of the payment identification code, authentication data including the unique key, payment content, or the like received from the external electronic device. For example, the electronic device (e.g., the processor 120 of FIG. 1) may confirm the payment at least on the basis of data (or a value) included in the unique key of the external electronic device. For example, the electronic device (e.g., the processor 120 of FIG. 1) may confirm a unique key, for example, a key unique to an application, and thus may confirm that the external electronic device is using a payment application downloaded from the server 106-1 for providing the same payment service as that used by the electronic device 101. In another example, the electronic device (e.g., the processor 120 of FIG. 1) may confirm a unique key, and thus may confirm that the external electronic device is using the same payment service as that used by the external electronic device. However, the present disclosure is not limited thereto.

In one example embodiment, the electronic device (e.g., the processor 120 of FIG. 1) may display the payment content received from the external electronic device on the display 160 operatively coupled to the electronic device (e.g., the processor 120). The electronic device may receive an input for agreeing the payment content (e.g., a touch input for an icon mapped with a function for selecting the agreement of the payment content, or a voice input designated to select the agreement of the payment content) from the user, and may confirm a payment at least on the basis of the received input. In another example embodiment, the electronic device (e.g., the processor 120) may receive a signature input for agreeing the payment content from the user, and may confirm the payment at least on the basis of the received input.

In one example embodiment, if the data regarding the payment identification code, the authentication data including the unique key, the payment content, or the like is encrypted, the electronic device (e.g., the processor 120 of FIG. 1) may decode the encoded data. For example, if a public key is exchanged between the electronic device 101 and the external electronic device and if the external electronic device encrypts the data regarding the payment identification code, the authentication data including the unique key, the payment content, or the like by using the public key of the electronic device 101, the electronic device 101 (e.g., the processor 120) may decode the encrypted data by using a private key of the electronic device. However, the decoding method may vary depending on an encrypting method performed by the external electronic device or an encrypting method pre-agreed with the external electronic device.

In operation 813, the electronic device (e.g., the processor 120 of FIG. 1) may transmit, to the external electronic device, authentication data including a unique key and an agreement message for the payment content. For example, the electronic device (e.g., the processor 120) may transmit, to the external electronic device, data which includes a unique key of the electronic device, an agreement message, for example, an agreement for the payment content input by the user, or a signature regarding the payment content.

In one example embodiment, the electronic device (e.g., the processor 120 of FIG. 1) may encrypt the authentication data including the unique key and the agreement message for the payment content, and may transmit the encrypted authentication data to the external electronic device. For example, the electronic device (e.g., the processor 120 of FIG. 1) may encrypt the authentication data including the unique key and the agreement message for the payment content by using at least one of the public key and the private key, and may transmit the encrypted data to the external electronic device. However, the encrypting method may be performed in various manners.

In operation 815, the electronic device (e.g., the processor 120 of FIG. 1) may receive a confirmation message (or a response message) from the external electronic device. For example, the electronic device (e.g., the processor 120 of FIG. 1) may receive the confirmation message indicating that the external electronic device confirms a unique key of the electronic device. However, according to an example embodiment, the operation of receiving the confirmation message of the electronic device in operation 815 may be omitted.

In operation 817, the electronic device (e.g., the processor 120 of FIG. 1) may transmit a payment-related request to the server 106-1. For example, the electronic device (e.g., the processor 120) may transmit information regarding a token, a token cryptogram, payment content, a payment identification code or the like to the server 106-1.

In operation 819, the electronic device (e.g., the processor 120 of FIG. 1) may receive a payment result from the server 106-1, and may display the received payment result by using the display 160 operatively coupled to the electronic device (e.g., the processor 120). For example, the electronic device (e.g., the processor 120 of FIG. 1) may receive the payment result from the server 106-1, for example, receive data including a payment approval or a payment rejection, and may display the received data including the payment approval or the payment rejection by using the display 160 operatively coupled to the electronic device (e.g., the processor 120).

Although not shown in FIG. 8, if the payment is complete, the electronic device (e.g., the processor 120 of FIG. 1) may release the payer mode, and may operate in (or return to) a normal mode.

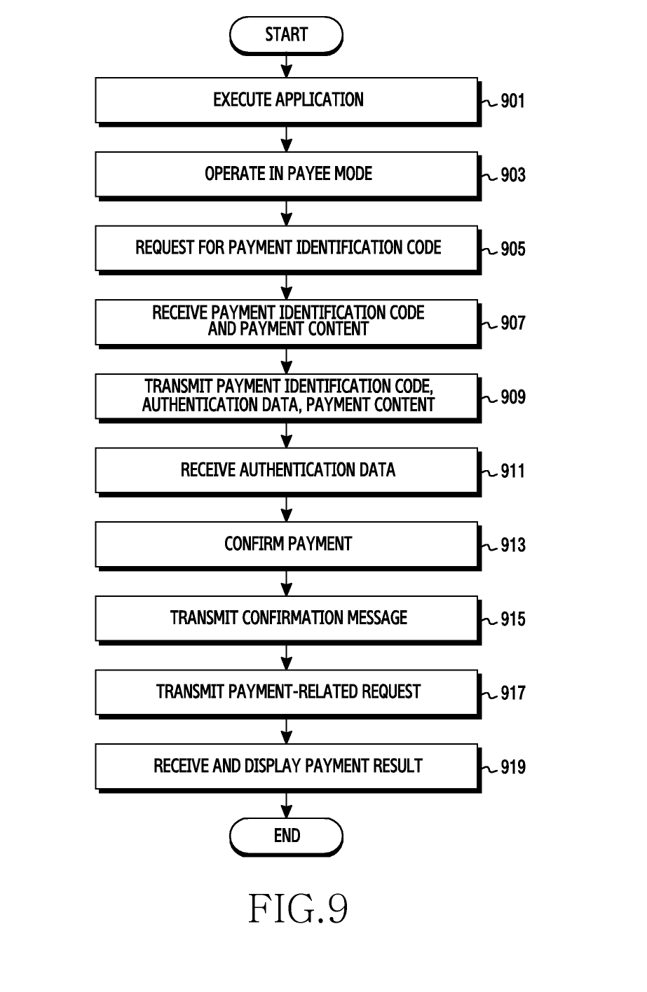

FIG. 9 is a flowchart illustrating an example method of providing an electronic payment by using an electronic device operating in a payee mode according to an example embodiment of the present disclosure.

Since an operation of executing the application of operation 901 is at least partially identical or similar to operation 801 of FIG. 8, a detailed description thereof will be omitted.

In operation 903, the electronic device 101 (e.g., the processor 120) may operate in the payee mode. For example, if a user interface for selecting the payee mode or the payer mode (e.g., a menu including the payee mode and the payer mode) is displayed according to an execution of a payment application, the electronic device 101 (e.g., the processor 120) may enter the payee mode at least on the basis of a user input for selecting the payee mode.

In one example embodiment, if the electronic device 101 (e.g., the processor 120) enters the payee mode, the electronic device (e.g., the processor 120 of FIG. 1) may display a user interface for performing a payment on the display 160. For example, the electronic device (e.g., the processor 120 of FIG. 1) may display a user interface for inputting payment content, for example, at least one of an item as a payment object, the number of payment objects, a price, a place, a time, a person involved in a trade, or the like on the display 160. However, the payment content is not limited to the aforementioned example.

In one example embodiment, if the electronic device 101 (e.g., the processor 120) enters the payee mode, the electronic device (e.g., the processor 120 of FIG. 1) may activate a near-distance communication module for performing the payment. For example, the electronic device (e.g., the processor 120 of FIG. 1) may activate the Bluetooth module 223, the NFC module 225, the WiFi module 222, the MST module 226, or the like to perform the payment. However, the near-distance communication module for performing the payment is not limited to the aforementioned example. In one example embodiment, the operation in which the electronic device (e.g., the processor 120 of FIG. 1) activates the near-distance communication module may be performed in response to an operation of receiving data including a payment identification code or the like by the electronic device from the server 106-1 in operation 907 to be describe below.

If the electronic device 101 (e.g., the processor 120) enters the payee mode in operation 903, the electronic device (e.g., the processor 120 of FIG. 1) may allow only an operation related to a payment among the operations, and may block an operation not related to the payment. The electronic device (e.g., the processor 120 of FIG. 1) may be configured not to perform any other commands except for a command related to the payment if many commands are performed in the processor. The electronic device (e.g., the processor 120 of FIG. 1) may restrict capability (e.g., a storage size, a usage amount, a processing rate, a resolution, etc.) of the electronic device 101. However, the present disclosure is not limited thereto.

In operation 905, the electronic device (e.g., the processor 120 of FIG. 1) may request the server 106-1 to provide a payment identification code (or paycode). In one example embodiment, the payment identification code may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device (or after being used one time). In another example, the payment identification code may include data which configures the payment identification code to be discarded after a designated time elapses. Further, in another example, the payment identification code may include data which configures the payment identification code to be requested again after a designated time elapses. Further, in another example, the payment identification code may include data which configures a notification to be displayed when a designated time elapses (or the designated time expires). In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In various example embodiments, the operation of requesting the server 106-1 to provide the payment identification code in operation 905 may further include an operation of transmitting payment content (or content for a payment) to the server 106-1. For example, the electronic device (e.g., the processor 120 of FIG. 1) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by a user and a transmission request is input to the server 106-1, the electronic device (e.g., the processor 120 of FIG. 1) may transmit the input information to the server 106-1. In one example embodiment, the electronic device (e.g., the processor 120 of FIG. 1) may further transmit user identification information (e.g., a user ID, etc.) of the external electronic device to the server 106-1 as the payment content.

In operation 907, the electronic device (e.g., the processor 120) may receive from the server 106-1 the payment content and the payment identification code generated in response to a payment identification code request. For example, the electronic device (e.g., the processor 120 of FIG. 1) may receive from the server 106-1 the payment content and the payment identification code including data in which a usage condition is designated. In one example embodiment, operation 907 may include an operation of activating the near-distance communication module. For example, if the near-distance communication module is not activated when entering the payee mode in the operation 903, the electronic device (e.g., the processor 120 of FIG. 1) may activate the near-distance communication module in response to payment identification transmission from the server 106-1.

In operation 909, the electronic device (e.g., the processor 120 of FIG. 1) may transmit to the external electronic device the payment identification code, authentication data including the unique key, payment content, or the like received from the server 160-1 by using the near-distance communication module.

In one example embodiment, the electronic device (e.g., the processor 120 of FIG. 1) may encrypt data regarding the payment identification code, the authentication data including the unique key, the payment content, or the like, and may transmit the encrypted data to the external electronic device by using the near-distance communication module. For example, if a public key is exchanged between the electronic device 101 and the external electronic device, the electronic device (e.g., the processor 120 of FIG. 1) may encrypt the data regarding the payment identification code, the authentication data including the unique key, the payment content, or the like by using the public key of the external electronic device. However, the encryption method is not limited thereto.

In operation 911, the electronic device (e.g., the processor 120 of FIG. 1) may receive authentication data including the unique key and an agreement message for the payment content from the external electronic device. For example, the electronic device (e.g., the processor 120 of FIG. 1) may receive data which includes a unique key of the external electronic device, an agreement message, for example, an agreement for the payment content input by the user, or a signature regarding the payment content.

In operation 913, the electronic device (e.g., the processor 120 of FIG. 1) may confirm a payment at least on the basis of data including authentication data received from the external electronic device, for example, data including the unique key and the agreement message for the payment content. For example, the electronic device (e.g., the processor 120 of FIG. 1) may confirm a unique key received from the external electronic device, for example, a key unique to a payment application of the external electronic device, and thus may confirm that the external electronic device is using a payment application downloaded from the server 106-1 for providing the same payment service as that used by the electronic device 101. In another example, the electronic device (e.g., the processor 120 of FIG. 1) may confirm a unique key, and thus may confirm that the external electronic device is using the same payment service as that used by the electronic device 101. However, the present disclosure is not limited thereto.

In one example embodiment, if authentication data received from the external electronic device is encrypted, the electronic device (e.g., the processor 120 of FIG. 1) may decode the encrypted authentication data. For example, if the authentication data is encrypted by using at least one of a public key and a private key, the electronic device (e.g., the processor 120 of FIG. 1) may decode the encrypted authentication data. However, the decoding method may be performed in various manners according to an encrypting method or the like.

In operation 915, upon confirming a payment, the electronic device (e.g., the processor 120 of FIG. 1) may transmit a confirmation message (or a response message) to the external electronic device. For example, the electronic device (e.g., the processor 120 of FIG. 1) may transmit to the external electronic device the confirmation message indicating that a unique key of the external electronic device is confirmed. However, according to an example embodiment, the operation of receiving the confirmation message of the electronic device in operation 915 may be omitted.

In operation 917, the electronic device (e.g., the processor 120 of FIG. 1) may transmit a payment-related request to the server 106-1. For example, the electronic device (e.g., the processor 120 of FIG. 1) may transmit payment content, account information for receiving a payment price, a payment identification code, or the like to the server 106-1.

In operation 919, the electronic device (e.g., the processor 120 of FIG. 1) may receive a payment result from the server 106-1, and may display the received payment result by using the display 160 operatively coupled to the electronic device (e.g., the processor 120). For example, the electronic device (e.g., the processor 120) may receive the payment result from the server 106-1, for example, receive data including a payment approval or a payment rejection, and may display the received data including the payment approval or the payment rejection by using the display 160 operatively coupled to the electronic device.

Although not shown in FIG. 9, if the payment is complete, the electronic device (e.g., the processor 120 of FIG. 1) may release the payee mode, and may operate in (or return to) a normal mode.

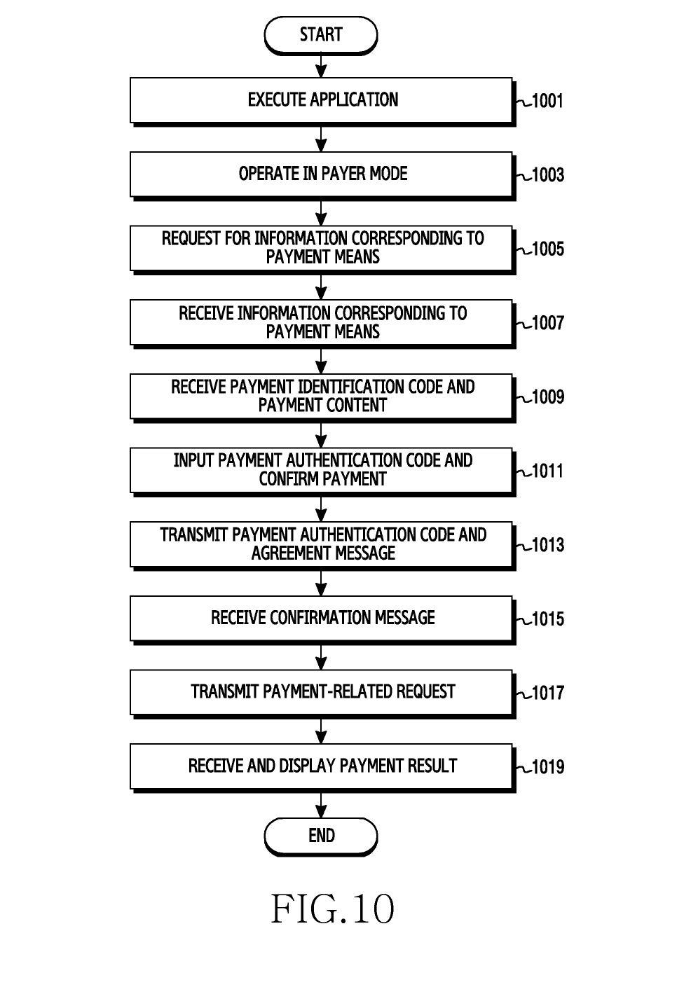

FIG. 10 is a flowchart illustrating an example method of providing an electronic payment by using an electronic device operating in a payer mode according to another example embodiment of the present disclosure.

Since an operation of executing an application of operation 1001 is at least partially identical or similar to operation 801 of FIG. 8, a detailed description thereof will be omitted. Unlike the operation 801, an operation of receiving a unique key from the server 106-1 may be omitted in the operation 1001. However, the present disclosure is not limited thereto.

Since operations 1003, 1005, and 1007 are at least partially identical or similar to operations 803, 805, and 807 of FIG. 8, a detailed description thereof will be omitted.

In operation 1009, the electronic device (e.g., the processor 120 of FIG. 1) may receive a payment identification code and payment content from an external electronic device. In various example embodiments, since operation 1009 is at least partially identical or similar to operation 809 of FIG. 8 except for the description related to the authentication data of operation 809 of FIG. 8, a detailed description thereof will be omitted.

In operation 1011, the electronic device (e.g., the processor 120 of FIG. 1) may input a payment authentication code, and may confirm the payment at least on the basis of the payment identification code, payment content, or the like received from the external electronic device. For example, the electronic device (e.g., the processor 120 of FIG. 1) may display the payment authentication code through the display 160 operatively coupled to the external electronic device, and may receive an input of the same code as the displayed payment authentication code from the user. In one example embodiment, if an input time is designated in the payment authentication code, the electronic device (e.g., the processor 120 of FIG. 1) may fail to authenticate a payment if the payment authentication code cannot be received from the user within the designated time.

In one example embodiment, the payment authentication code may include data required when mutual authentication is performed between the electronic device 101 and the external electronic device. In one example embodiment, the payment authentication code may be issued (or generated) by the server 106-1. In one example embodiment, the payment authentication code may include data which designates a user condition (or a validity). For example, the payment authentication code may include data which designates that it is invalid if the payment authentication code is used one time. In another example, the payment authentication code may include time information (e.g., timestamp), and may include data which designates that it is invalid if not used within a designated time. For example, the payment authentication code may include data which designates that the payment authentication code is invalid if the payment authentication code is not input to the external electronic device within a designated time after the electronic device receives the payment authentication code from the server 106-1. In another example, the payment authentication code may include data which designates that it is valid only for a trade (or a payment) requested by the external electronic device. However, data included in the payment authentication code to designate the user condition is not limited to the aforementioned example.

In one example embodiment, the electronic device (e.g., the processor 120 of FIG. 1) may display the payment content received from the external electronic device on the display 160. The electronic device (e.g., the processor 120 of FIG. 1) may receive an input for agreeing the payment content (e.g., a touch input for an icon mapped with a function for selecting the agreement of the payment content, or a voice input designated to select the agreement of the payment content) from a user, and may confirm a payment at least on the basis of the received input. In another example embodiment, the electronic device (e.g., the processor 120 of FIG. 1) may receive a signature input for agreeing the payment content from the user, and may confirm the payment at least on the basis of the received input.

In one example embodiment, if the data regarding the payment identification code, the payment content, or the like is encrypted, the electronic device (e.g., the processor 120 of FIG. 1) may decode the encoded data. For example, if a public key is exchanged between the electronic device 101 and the external electronic device and if the external electronic device encrypts the data regarding the payment identification code, the payment content, or the like by using the public key of the electronic device 101, the electronic device (e.g., the processor 120 of FIG. 1) may decode the encrypted data by using a private key of the electronic device 101. However, the decoding method may vary depending on an encrypting method performed by the external electronic device or an encrypting method pre-agreed with the external electronic device.

In operation 1013, the electronic device (e.g., the processor 120 of FIG. 1) may transmit to the external electronic device the payment authentication code input by the user and an agreement (or confirmation) message for payment content. For example, the electronic device (e.g., the processor 120 of FIG. 1) may transmit, to the external electronic device, data which includes a code input to the electronic device by the user by watching the payment authentication code displayed on the external electronic device, an agreement message, for example, an agreement for the payment content input by the user, or a signature regarding the payment content.

In one example embodiment, the electronic device (e.g., the processor 120 of FIG. 1) may encrypt authentication data including the payment authentication code input by the user and the agreement message for the payment content, and may transmit the encrypted authentication data to the external electronic device. For example, the electronic device (e.g., the processor 120 of FIG. 1) may encrypt the payment authentication code and the agreement message for the payment content by using at least one of the public key and the private key, and may transmit the encrypted data to the external electronic device. However, the encrypting method may be performed in various manners.

In another example embodiment, the electronic device (e.g., the processor 120 of FIG. 1) may encrypt the agreement message for the payment content by using the payment authentication code input by the user, and may transmit the encrypted agreement message to the external electronic device. However, the present disclosure is not limited thereto.

In operation 1015, the electronic device (e.g., the processor 120 of FIG. 1) may receive a confirmation message for confirming that the payment is mutually authenticated from the external electronic device. For example, if the external electronic device confirms that the payment authentication code received from the electronic device 101 is identical to the payment authentication code received from the server 106-1 and confirms that the agreement message for the payment content is received from the electronic device 101, the external electronic device may transmit to the electronic device 101 a confirmation message for confirming that the payment is mutually authenticated.

In various example embodiments, since operations 1017 and 1019 of FIG. 10 are at least partially identical or similar to operations 817 and 819 of FIG. 8, a detailed description thereof will be omitted.

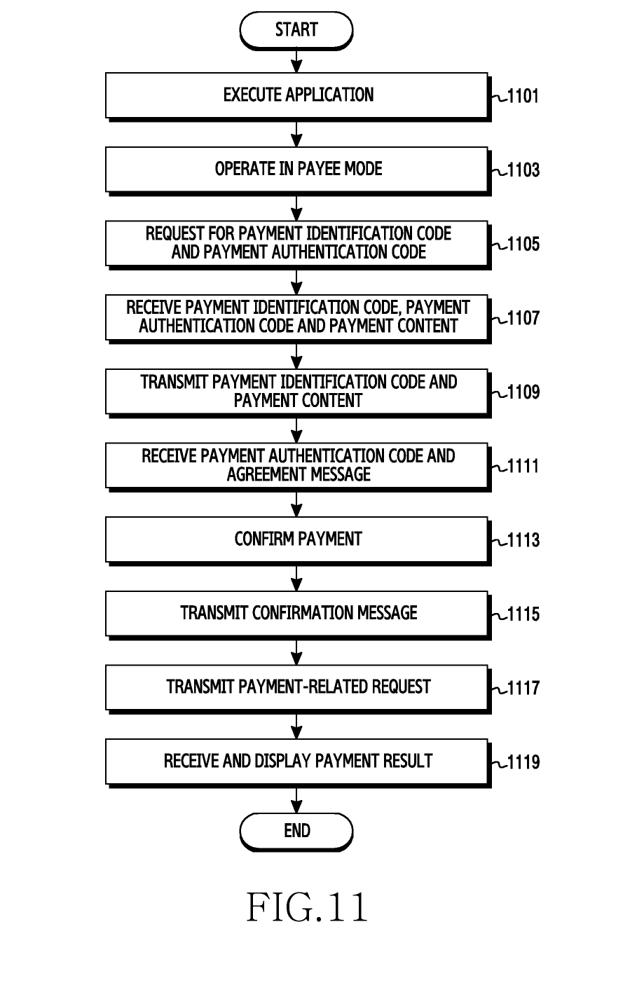

FIG. 11 is a flowchart illustrating an example method of providing an electronic payment by using an electronic device operating in a payee mode according to another example embodiment of the present disclosure.

Since operations 1101 and 1103 are at least partially identical or similar to operations 901 and 903 of FIG. 9, a detailed description thereof will be omitted.

In operation 1105, the electronic device (e.g., the processor 120 of FIG. 1) may request the server 106-1 to provide a payment identification code (or paycode) and a payment authentication code. In one example embodiment, the payment authentication code may include data required when mutual authentication is performed between the electronic devices. In one example embodiment, the payment authentication code may be issued (or generated) by the server 106-1. In one example embodiment, the payment authentication code may include data which designates a user condition (or a validity). For example, the payment authentication code may include data which designates that it is invalid if the payment authentication code is used one time. In another example, the payment authentication code may include time information (e.g., timestamp), and may include data which designates that it is invalid if not used within a designated time. For example, the payment authentication code may include data which designates that the payment authentication code is invalid if the payment authentication code is not input to the external electronic device within a designated time after the electronic device (e.g., the processor 120 of FIG. 1) receives the payment authentication code from the server 106-1. In another example, the payment authentication code may include data which designates that it is valid only for a trade (or a payment) requested by the electronic device. However, data included in the payment authentication code to designate the user condition is not limited to the aforementioned example.

In various example embodiments, the operation of requesting the server 106-1 to provide the payment identification code in operation 1105 may further include an operation of transmitting payment content (or content for a payment) to the server 106-1. For example, the electronic device (e.g., the processor 120 of FIG. 1) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by a user and a transmission request is input to the server 106-1, the electronic device (e.g., the processor 120 of FIG. 1) may transmit the input information to the server 106-1.

In operation 1107, the electronic device (e.g., the processor 120 of FIG. 1) may receive from the server 106-1 payment content together with a payment identification code and a payment authentication code in response to a payment identification code request. For example, the electronic device (e.g., the processor 120) may receive from the server 106-1 the payment content together with the payment identification code and payment authentication code including data in which a usage condition is designated.

In one example embodiment, if the payment authentication code is received from the server 106-1, the electronic device (e.g., the processor 120 of FIG. 1) may display the payment authentication code received by using the display 160 operatively coupled to the electronic device 101 (e.g., the processor 120).

In one example embodiment, operation 1107 may include an operation of activating a near-distance communication module. For example, if the near-distance communication module is not activated when entering the payee mode in operation 1103, the electronic device (e.g., the processor 120 of FIG. 1) may activate the near-distance communication module in response to payment identification transmission from the server 106-1.

In operation 1109, the electronic device (e.g., the processor 120 of FIG. 1) may transmit to the external electronic device the payment identification code, payment content, or the like received from the server 106-1 by using the near-distance communication module.

In one example embodiment, the electronic device (e.g., the processor 120 of FIG. 1) may encrypt data regarding the payment identification code, the payment content, or the like, and may transmit the encrypted data to the external electronic device. For example, if a public key is exchanged between the external electronic device and the electronic device, the electronic device (e.g., the processor 120) may encrypt the data regarding the payment identification code, the payment content, or the like by using the public key of the external electronic device. However, the encryption method is not limited thereto.

In operation 1111, the electronic device (e.g., the processor 120 of FIG. 1) may receive from the external electronic device the payment authentication code input by the user and an agreement (or confirmation) message for payment content. For example, the electronic device (e.g., the processor 120 of FIG. 1) may receive, from the external electronic device, data which includes a code input to the external electronic device by the user of the external electronic device by watching the payment authentication code displayed on the external electronic device, an agreement message, for example, an agreement for the payment content input by the user, or a signature regarding the payment content.

In operation 1113, the electronic device (e.g., the processor 120 of FIG. 1) may confirm the payment at least on the basis of the agreement message for the input payment authentication code and payment content received from the external electronic device. For example, the electronic device (e.g., the processor 120 of FIG. 1) may confirm whether the payment authentication code received from the external electronic device is identical to the payment authentication code received from the server 106-1. In one example embodiment, if the electronic device (e.g., the processor 120 of FIG. 1) confirms that the payment authentication code received from the external electronic device is different from the payment authentication code received from the server 106-1, or if the agreement message is not received from the external electronic device, the electronic device (e.g., the processor 120 of FIG. 1) may confirm that mutual authentication has failed. In one example embodiment, if it is confirmed that the mutual authentication has failed, in order to continuously authenticate the payment, the electronic device (e.g., the processor 120 of FIG. 1) may repeat operations 1105 to 1109. However, the present disclosure is not limited thereto

In operation 1115, if it is confirmed in operation 1113 that the electronic device (e.g., the processor 120 of FIG. 1) confirms that the payment authentication code received from the external electronic device is identical to the payment authentication code received from the server 106-1 and confirms that the agreement message for the payment content is received from the external electronic device, the electronic device (e.g., the processor 120 of FIG. 1) may transmit to the external electronic device a confirmation message for confirming that the payment is mutually authenticated.

In various example embodiments, since operations 1117 and 1119 of FIG. 10 are at least partially identical or similar to operations 917 and 919 of FIG. 9, a detailed description thereof will be omitted.

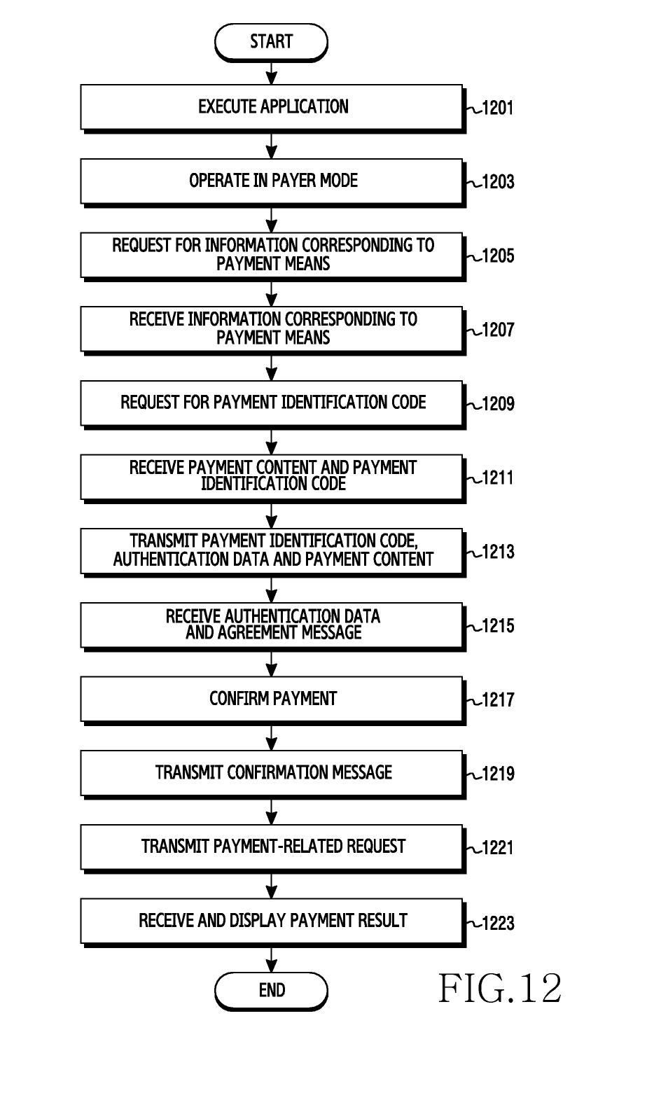

FIG. 12 is a flowchart illustrating an example method of providing an electronic payment by using an electronic device operating in a payer mode according to another example embodiment of the present disclosure.

Since operations 1201 to 1207 of FIG. 12 are at least partially identical or similar to operations 801 to 807 of FIG. 8, a detailed description thereof will be omitted.

In operation 1209, the electronic device (e.g., the processor 120 of FIG. 1) operating in the payer mode may request the server 106-1 to provide a payment identification code (or paycode). In one example embodiment, the payment identification code may include data for authenticating a payment. For example, the payment identification code may include data for identifying (or specifying) a trade. In one example embodiment, the payment identification code may include data which designates a usage condition (or a validity). For example, the payment identification code may include data which configures the payment identification code to be discarded after being used only for a trade requested by the electronic device 101 (or after being used one time). In another example, the payment identification code may include data which configures the payment identification code to be discarded after a designated time elapses. Further, in another example, the payment identification code may include data which configures the payment identification code to be requested again after a designated time elapses. Further, in another example, the payment identification code may include data which configures a notification to be displayed when a designated time elapses (or the designated time expires). In one example embodiment, the data which configures the payment identification code to be discarded after the designated time elapses may include time information (e.g., timestamp) regarding the designated time. Further, in another example, the payment identification code may include data which designates a usage condition such as a designated place (e.g., a foreign country, a school zone, etc.), a designated time (e.g., a time between 12 a.m. and 8 a.m.), or a designated price (e.g., less than or equal to 1 million won). Further, in another example, the payment identification code may include data which designates a usage condition at least one the basis of user identification information (e.g., a foreigner or a local resident, a gender, an age, etc.). However, the designated condition is not limited to the aforementioned example.

In various example embodiments, the operation of requesting the server 106-1 to provide the payment identification code in operation 1209 may further include an operation of transmitting payment content (or content for a payment) to the server 106-1. For example, the electronic device (e.g., the processor 120 of FIG. 1) may transmit information including the payment content, for example, a payment location, a payment date and time, an item, the number of payment objects, a payment price, or the like, to the server 106-1. For example, if the information regarding the payment location, the payment date and time, the item, the number of payment objects, the payment price, or the like is input to a user interface by a user and a transmission request is input to the server 106-1, the electronic device may transmit the input information to the server 106-1.

In operation 1211, the electronic device (e.g., the processor 120 of FIG. 1) may receive from the server 106-1 the payment content and the payment identification code generated in response to a payment identification code request. For example, the electronic device (e.g., the processor 120 of FIG. 1) may receive from the server 106-1 the payment content and the payment identification code including data in which a usage condition is designated.

In one example embodiment, operation 1211 may include an operation of activating a near-distance communication module. For example, if the near-distance communication module is not activated when entering the payer mode in the operation 1203, the electronic device (e.g., the processor 120 of FIG. 1) may activate the near-distance communication module in response to payment identification code reception from the server 106-1.

In operation 1213, the electronic device (e.g., the processor 120 of FIG. 1) may transmit to the external electronic device the payment identification code, authentication data including the unique key, payment content, or the like received from the server 160-1 by using the near-distance communication module.

In one example embodiment, the electronic device (e.g., the processor 120 of FIG. 1) may encrypt data regarding the payment identification code, the authentication data including the unique key, the payment content, or the like, and may transmit the encrypted data to the external electronic device by using the near-distance communication module. For example, if a public key is exchanged between the electronic device 101 and the external electronic device, the electronic device (e.g., the processor 120 of FIG. 1) may encrypt the data regarding the payment identification code, the authentication data including the unique key, the payment content, or the like by using the public key of the external electronic device. However, the encryption method is not limited thereto.

In operation 1215, the electronic device (e.g., the processor 120 of FIG. 1) may receive authentication data including the unique key of the external electronic device and an agreement message for the payment content from the external electronic device. For example, the electronic device (e.g., the processor 120 of FIG. 1) may receive, from the external electronic device, data which includes a unique key of the external electronic device, an agreement message, for example, an agreement for the payment content input by the user, or a signature regarding the payment content.

In operation 1217, the electronic device (e.g., the processor 120 of FIG. 1) may confirm a payment at least on the basis of data including authentication data received from the external electronic device, for example, data including the unique key and the agreement message for the payment content. For example, the electronic device (e.g., the processor 120 of FIG. 1) may confirm a unique key received from the external electronic device, for example, a key unique to a payment application of the external electronic device, and thus may confirm that the external electronic device is using a payment application downloaded from the server 106-1 for providing the same payment service as that used by the electronic device 101. In another example, the electronic device (e.g., the processor 120 of FIG. 1) may confirm a unique key, and thus may confirm that the external electronic device is using the same payment service as that used by the electronic device 101. However, the present disclosure is not limited thereto.

In one example embodiment, if authentication data received from the external electronic device is encrypted, the electronic device (e.g., the processor 120 of FIG. 1) may decode the encrypted authentication data. For example, if the authentication data is encrypted by using at least one of a public key and a private key, the electronic device may decode the encrypted authentication data. However, the decoding method may be performed in various manners according to an encrypting method or the like.

In operation 1219, upon confirming a payment, the electronic device (e.g., the processor 120 of FIG. 1) may transmit a confirmation message (or a response message) to the external electronic device. For example, the electronic device (e.g., the processor 120 of FIG. 1) may transmit to the external electronic device the confirmation message indicating that a unique key of the external electronic device is confirmed. However, according to an example embodiment, the operation of receiving the confirmation message of the external electronic device in operation 1219 may be omitted.

In operation 1221, the electronic device (e.g., the processor 120 of FIG. 1) may transmit a payment-related request to the server 106-1. For example, the electronic device (e.g., the processor 120) may transmit information regarding a token, a token cryptogram, payment content, a payment identification code or the like to the server 106-1.

In operation 1223, the electronic device (e.g., the processor 120 of FIG. 1) may receive a payment result from the server 106-1, and may display the received payment result by using the display 160 operatively coupled to the electronic device 101 (e.g., the processor 120). For example, the electronic device (e.g., the processor 120 of FIG. 1) may receive the payment result from the server 106-1, for example, receive data including a payment approval or a payment rejection, and may display the received data including the payment approval or the payment rejection by using the display 160 operatively coupled to the electronic device 101 (e.g., the processor 120).

Although not shown in FIG. 12, if the payment is complete, the electronic device 101 may release the payer mode, and may operate in (or return to) a normal mode.

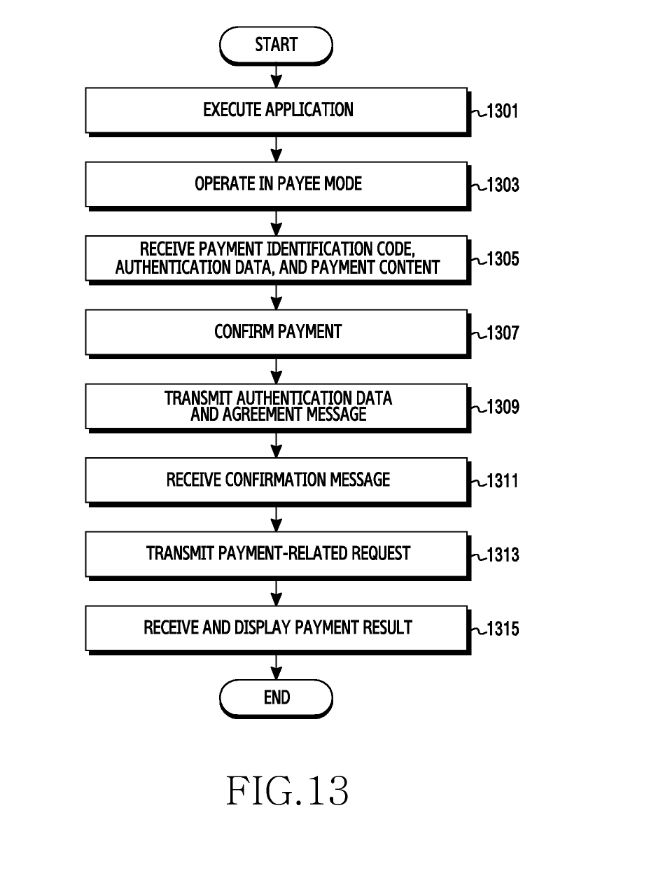

FIG. 13 is a flowchart illustrating an example method of providing an electronic payment by using an electronic device operating in a payee mode according to another example embodiment of the present disclosure.

Operation 1301 of FIG. 13 is at least partially identical or similar to operation 901 of FIG. 9, a detailed description thereof will be omitted.

In operation 1303, the electronic device 101 (e.g., the processor 120) may operate in the payee mode. For example, if a user interface for selecting the payee mode or the payer mode (e.g., a menu including the payee mode and the payer mode) is displayed according to an execution of a payment application, the electronic device 101 (e.g., the processor 120) may enter the payee mode at least on the basis of a user input for selecting the payee mode.

In operation 1305, the electronic device (e.g., the processor 120 of FIG. 1) may receive a payment identification code, authentication data including a unique key, and payment content or the like from an external electronic device by using a near-distance communication module.

In operation 1307, the electronic device (e.g., the processor 120 of FIG. 1) may confirm a payment at least on the basis of the payment identification code, authentication data including the unique key, payment content, or the like received from the external electronic device. For example, the electronic device (e.g., the processor 120 of FIG. 1) may confirm the payment at least on the basis of data (or a value) included in the unique key of the external electronic device.

For example, the electronic device (e.g., the processor 120 of FIG. 1) may confirm a unique key, for example, a key unique to an application, and thus may confirm that the external electronic device is using a payment application downloaded from the server 106-1 for providing the same payment service as that used by the electronic device 101. In another example, the electronic device (e.g., the processor 120 of FIG. 1) may confirm a unique key, and thus may confirm that the external electronic device is using the same payment service as that used by the electronic device 101. However, the present disclosure is not limited thereto.

In one example embodiment, the electronic device (e.g., the processor 120 of FIG. 1) may display the payment content received from the external electronic device on the display 160. The electronic device (e.g., the processor 120 of FIG. 1) may receive an input for agreeing the payment content (e.g., a touch input for an icon mapped with a function for selecting the agreement of the payment content, or a voice input designated to select the agreement of the payment content) from a user, and may confirm a payment at least on the basis of the received input. In another example embodiment, the electronic device (e.g., the processor 120 of FIG. 1) may receive a signature input for agreeing the payment content from the user, and may confirm the payment at least on the basis of the received input.

In one example embodiment, if the data regarding the payment identification code, the authentication data including the unique key, the payment content, or the like is encrypted, the electronic device (e.g., the processor 120 of FIG. 1) may decode the encoded data. For example, if a public key is exchanged between the electronic device 101 and the external electronic device and if the external electronic device encrypts the data regarding the payment identification code, the authentication data including the unique key, the payment content, or the like by using the public key of the external electronic device, the electronic device (e.g., the processor 120 of FIG. 1) may decode the encrypted data by using a private key of the external electronic device. However, the decoding method may vary depending on an encrypting method performed by the external electronic device or an encrypting method pre-agreed with the external electronic device.

In operation 1309, the electronic device (e.g., the processor 120 of FIG. 1) may transmit, to the external electronic device, authentication data including a unique key and an agreement message for the payment content. For example, the electronic device (e.g., the processor 120 of FIG. 1) may transmit, to the external electronic device, data which includes a unique key of the external electronic device, an agreement message, for example, an agreement for the payment content input by the user, or a signature regarding the payment content.

In one example embodiment, the electronic device (e.g., the processor 120 of FIG. 1) may encrypt the authentication data including the unique key and the agreement message for the payment content, and may transmit the encrypted authentication data to the external electronic device. For example, the electronic device (e.g., the processor 120 of FIG. 1) may encrypt the authentication data including the unique key and the agreement message for the payment content by using at least one of the public key and the private key, and may transmit the encrypted data to the external electronic device. However, the encrypting method may be performed in various manners.

In operation 1311, when the external electronic device confirms a payment, the electronic device (e.g., the processor 120 of FIG. 1) may receive a confirmation message from the external electronic device. For example the electronic device may receive the confirmation message indicating that a unique key of the electronic device is confirmed from the external electronic device. However, according to an example embodiment, the operation of receiving the confirmation message of the electronic device in operation 1311 may be omitted.

In operation 1313, the electronic device (e.g., the processor 120 of FIG. 1) may transmit a payment-related request to the server 106-1. For example, the electronic device may transmit payment content, account information for receiving a payment price, a payment identification code, or the like to the server 106-1.

In operation 1315, the electronic device (e.g., the processor 120 of FIG. 1) may receive a payment result from the server 106-1, and may display the received payment result.

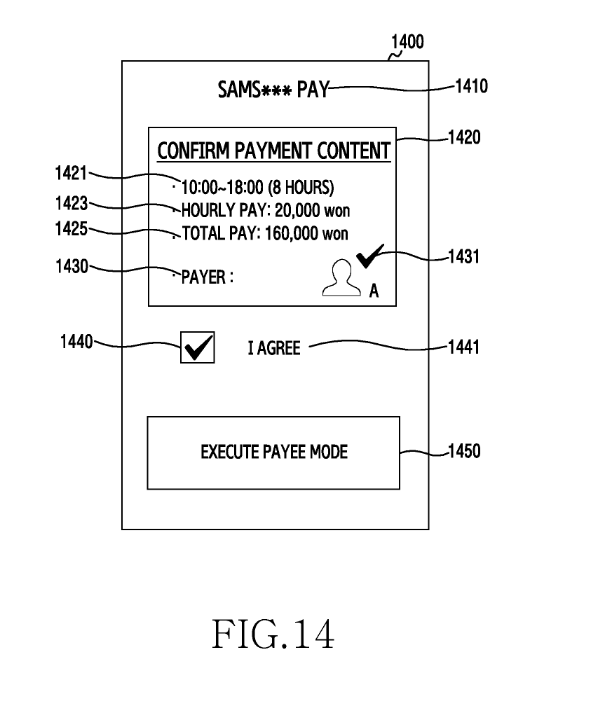

FIGS. 14, 15, 16 and FIG. 17 are diagrams illustrating examples of a method of providing an electronic payment according to various example embodiments of the present disclosure. For example, FIG. 14 to FIG. 17 may correspond to a scenario in which an employer is A and an employee is B, and A pays a wage to B. However, technical features of the present disclosure are not limited to the scenario exemplified through FIG. 14 to FIG. 17.

Referring to FIG. 14 to FIG. 17, in one example embodiment, FIG. 14 illustrates a screen 1400 in which the electronic device 101 (e.g., the processor 120) receives an input for operating a payment request mode (or a payee mode) through the display 160 operatively coupled to the electronic device (e.g., the processor 120). In FIG. 14, the electronic device 101 (e.g., the processor 120) may display a name 1410 of a payment application, an object 1420 for displaying payment content, an object 1440 for inputting an agreement for the payment content, an object 1450 for entering the payee mode, or the like. In one example embodiment, the object 1420 for displaying the payment content may include office hour information 1421 of B, hourly wage information 1423, total payment price (or total paid amount) information 1425, employer information 1430, confirmation display 1431 for the employer information of an employer, or the like. However, the payment content is not limited to the example of FIG. 14. For example, if a trade is made for a product, the payment content may include information regarding a payment location, a payment date and time, an item, the number of payment objects, a payment price, or the like.

In one example embodiment, upon receiving from a user an input for the object 1450 for entering the payee mode, the electronic device 101 (e.g., the processor 120) may transmit data including a request for a payment identification code to a server.

In one example embodiment, upon receiving the data including the payment identification code or the like from the server, the electronic device 101 (e.g., the processor 120) may activate a near-distance communication module. For example, upon receiving the payment identification code from the server, the electronic device 101 (e.g., the processor 120) may activate the NFC module 225, the MST module 226, or the like. However, since the near-distance communication module to be activated is not limited thereto, the Bluetooth module 223, the WiFi module 222, or the like may be activated according to an example embodiment.

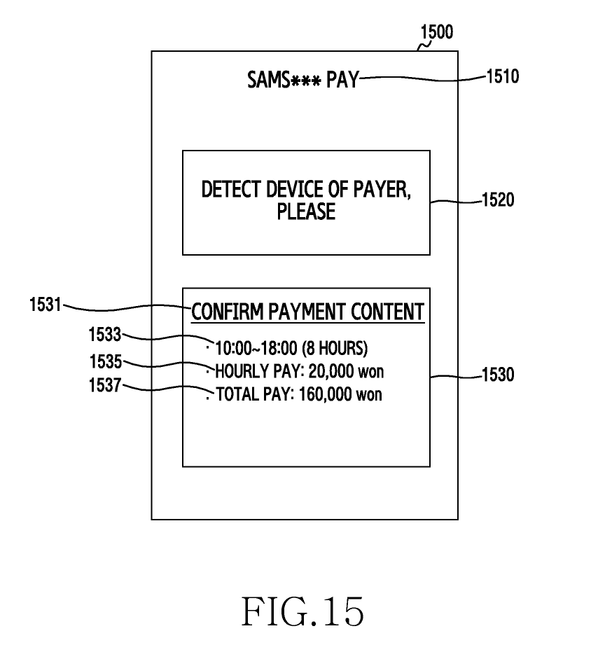

In one example embodiment, FIG. 15 illustrates a screen 1500 for guiding to perform near-distance (short-range) communication between electronic devices for performing a payment operation if the near-distance communication module is activated. For example, the electronic device 101 (e.g., the processor 120) may display a screen including a payment application name 1510, an object 1520 including a text for guiding to perform communication such as “Detect a device of a payer, please.”, payment content 1530, or the like by using the display 160 operatively coupled to the electronic device 101 (e.g., the processor 120). In one example embodiment, the payment content 1530 may include a text 1531 for displaying a payment content configuration, office hour information 1533 of B, hourly wage information 1535, total payment price (or total paid amount) information 1537, or the like. However, the present disclosure is not limited thereto.

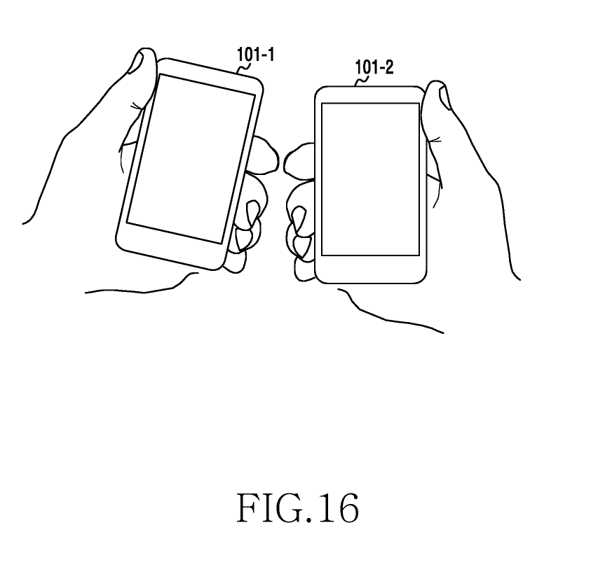

In one example embodiment, FIG. 16 illustrates an operation of performing near-distance (i.e., short-range) communication between electronic devices 101-1 and 101-2 for performing a payment operation. For example, if it is located (or in contact) within a designated distance, the electronic devices may perform a tagging operation by using, for example, the NFC module 225 or the MST module 226.

In one example embodiment, during the near-distance communication is performed between the electronic devices, information used for the payment, such as, a payment identification code, authentication data, a unique key, and a payment authentication code, or the like, may be transmitted/received between the electronic devices.

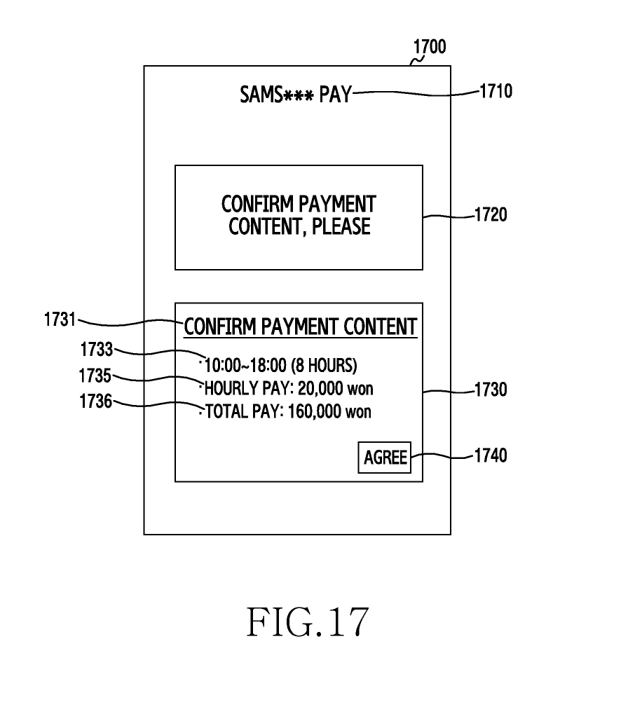

In an example embodiment, FIG. 17 illustrates a screen 1700 to be displayed on an electronic device of an employer upon receiving data including payment content or the like from an electronic device of an employee. For example, the electronic device 101 (e.g., the processor 120) may display a payment application name 1710, an object 1720 including a text for guiding a confirmation of payment content such as “Confirm the payment content, please”, an object 1730 including the payment content, an object 1740 for receiving an agreement for the payment, or the like by using the display 160 operatively coupled to the electronic device (e.g., the processor 120). In one example embodiment, the object 1730 including the payment content may include a text 1731 for displaying a payment content configuration, office hour information 1733 of B, hourly wage information 1735, total payment price (or total paid amount) information 1736, or the like. However, the present disclosure is not limited thereto.

In one example embodiment, the electronic device 101 (e.g., the processor 120) may receive an input for the object 1740 for receiving an input of an agreement for a payment from an employer, and may transmit a confirmation message to an electronic device of an employee. In one example embodiment, upon receiving an agreement message (or a response message) from the electronic device of the employee, mutual authentication to be performed between the electronic device of the employer and the electronic device of the employee may be complete.

In one example embodiment, upon receiving information of an approval for the payment from the server, a trade (or a payment) between the employer and the employee may be complete.

According to various example embodiments of the present disclosure, a method of providing an electronic payment function and an electronic device supporting the method are provided, so that an easy and reliable trade can be provided by operating in a payee mode (or a buyer mode) or a payer mode (or a consumer mode) on the basis of an input and by mutually authenticating a trading partner by using a near-distance communication module.

According to various example embodiments of the present disclosure, a method may include receiving an input, changing the electronic device to a state capable of recording information on a payment at least on the basis of the input, receiving, from a first external electronic device, authentication data related to a payment performed between the electronic device and the first external electronic device by using the near-distance communication module at least on the basis of the change of the state, and transmitting, to a second external electronic device, a request related to the payment at least on the basis of the authentication data.

In one example embodiment, the electronic device may be configured to operate in any one of a payee mode and a payer mode for the payment.

In one example embodiment, the method may further include requesting the second external electronic device to provide a payment identification code related to the payment.

In one example embodiment, the transmitting may further include transmitting the payment identification code and content for the payment to the second external electronic device. The content related to the payment may include at least one of a payment location, a payment date and time, an item, the number of payment objects, and a payment price.

In one example embodiment, the electronic device may operate in the payer mode for the payment. The method may further include receiving information corresponding to at least one payment means from the second external electronic device.

In one example embodiment, the method may further include transmitting the content for the payment to the first external electronic device by using the near-distance communication module.

In one example embodiment, the authentication data may be configured to include a public key and private key of the first external electronic device, a payment authentication code related to the payment, or an agreement message for content for the payment.

In one example embodiment, the method may further include transmitting to the first external electronic device whether a condition for performing the payment with respect to the first external electronic device is satisfied at least on the basis of the authentication data.

In one example embodiment, the method may further include not transmitting the request when the electronic device belongs to a designated condition.

In one example embodiment, there may be provided a computer readable recording medium having a program for executing operations of receiving an input from an electronic device, changing the electronic device to a state capable of recording information on a payment at least on the basis of the input, receiving, from a first external electronic device, authentication data related to a payment performed between the electronic device and the first external electronic device by using the near-distance communication module at least on the basis of the change of the state, and transmitting, to a second external electronic device, a request related to the payment at least on the basis of the authentication data.

Meanwhile, the aforementioned example embodiments of the present disclosure may be writable as a program executable in a computer, and may be implemented in a general purpose digital computer for operating the program by using a computer-readable recording medium. In addition, a data structure used in the aforementioned example embodiment of the present disclosure may be recorded in the computer-readable recording medium through several means. The computer-readable recording medium includes a storage medium such as a magnetic medium (e.g., a Read Only Memory (ROM), a floppy disc, a hard disc, etc.) and an optical storage medium (e.g., a Compact Disc-ROM (CD-ROM), a Digital Versatile Disc (DVD), etc.).

While the present disclosure has been illustrated and described with reference to certain example embodiments thereof, it will be understood by those skilled in the art that various changes in form and details may be made therein without departing from the spirit and scope of the present disclosure as defined by the appended claims and their equivalents. Therefore, it shall be considered that the disclosed example embodiments are provided not for a restrictive purpose but for an illustrative purpose. The scope of the disclosure is defined not by the detailed description of the disclosure but by the appended claims and their equivalents, and all differences within the scope will be construed as being included in the present disclosure.

What is claimed is:

1. An electronic device comprising:
a short-range communication module comprising short-range communication circuitry; and
a processor, wherein the processor is configured to:
receive an input;
change the electronic device to a state capable of recording information of a payment based on the input;
receive, from a first external electronic device, authentication data related to a payment performed between the electronic device and the first external electronic device using the short-range communication module based on the change of state; and
transmit, to a second external electronic device, a request related to the payment based on the authentication data.

2. The electronic device of claim 1, wherein the electronic device is configured to operate in any one of: a payee mode and a payer mode for the payment.

3. The electronic device of claim 1, wherein the processor is configured to request the second external electronic device to provide a payment identification code related to the payment.

4. The electronic device of claim 3,
wherein the processor is configured to transmit the payment identification code and content for the payment to the second external electronic device as part of an operation of transmitting the request related to the payment, and
wherein the content related to the payment comprises at least one of: a payment location, a payment date and time, an item, the number of payment objects, and a payment price.

5. The electronic device of claim 1,
wherein the electronic device is configured to operate in the payer mode for the payment, and
wherein the processor is configured to receive information corresponding to at least one form of payment from the second external electronic device.

6. The electronic device of claim 1, wherein the processor is configured to transmit the content for the payment to the first external electronic device using the short-range communication module.

7. The electronic device of claim 1, wherein the authentication data comprises one or more of a public key and private key of the first external electronic device, a payment authentication code related to the payment, or an agreement message for content for the payment.

8. The electronic device of claim 1, wherein the processor is configured to transmit, to the first external electronic device, whether a condition for performing the payment with respect to the first external electronic device is satisfied based on the authentication data.

9. The electronic device of claim 1, wherein the processor is configured to not transmit the request when the electronic device is in a predetermined condition.

10. The electronic device of claim 1, wherein the processor is configured to output a result of the payment-related request received from the second external electronic device using a display or audio module comprising audio circuitry operatively coupled to the processor.

11. An electronic payment method comprising:
receiving an input;
changing an electronic device to a state capable of recording information of a payment based on the input;
receiving, from a first external electronic device, authentication data related to a payment performed between the electronic device and the first external electronic device using a short-range communication module based on the change of the state; and
transmitting, to a second external electronic device, a request related to the payment based on the authentication data.

12. The method of claim 11, wherein the electronic device is configured to operate in any one of: a payee mode and a payer mode for the payment.

13. The method of claim 11, further comprising requesting the second external electronic device to provide a payment identification code related to the payment.

14. The method of claim 13,
wherein the transmitting further comprises transmitting the payment identification code and content for the payment to the second external electronic device, and
wherein the content related to the payment comprises at least one of: a payment location, a payment date and time, an item, the number of payment objects, and a payment price.

15. The method of claim 11, wherein the electronic device is configured to operate in the payer mode for the payment, and further comprising receiving information corresponding to at least one form of payment from the second external electronic device.

16. The method of claim 11, further comprising transmitting the content for the payment to the first external electronic device using the short-range communication module.

17. The method of claim 11, wherein the authentication data is comprises one or more of: a public key and private key of the first external electronic device, a payment authentication code related to the payment, or an agreement message for content for the payment.

18. The method of claim 11, further comprising transmitting to the first external electronic device whether a condition for performing the payment with respect to the first external electronic device is satisfied based on the authentication data.

19. The method of claim 11, further comprising not transmitting the request when the electronic device is in a predetermined condition.

20. A non-transitory computer readable recording medium having recorded thereon a program which, when executed by a processor, causes and electronic device to perform operations comprising:
receiving an input from an electronic device;
changing the electronic device to a state capable of recording information of a payment based on the input;
receiving, from a first external electronic device, authentication data related to a payment performed between the electronic device and the first external electronic device using the short-range communication module based on the change of the state; and
transmitting, to a second external electronic device, a request related to the payment based on the authentication data.
